(19) United States
(12) Patent Application Publication
(10) Pub. No.: US 2026/0269851 A1
(43) Pub. Date: Sep. 10, 2026

(54) QUANTIZED AMPLIFICATION BY A SET OF POWER AMPLIFIERS

(71) Applicant: QDAComm LLC, Raleigh, NC (US)

(72) Inventors: Paulo Carvalho, Lisboa (PT); Rui Dinis, Costa da Caparica (PT); João Oliveira, Parede (PT)

(73) Assignee: QDAComm LLC, Raleigh, NC (US)

(21) Appl. No.: 19/072,574

(22) Filed: Mar. 6, 2025

(51) Int. Cl. H04B 1/04

(52) U.S. Cl. CPC H04B 1/0475; H04B 2001/045

(57) ABSTRACT

Systems and methods of performing quantized amplification by a set of power amplifiers are provided. In one exemplary embodiment, an electronic device includes a set of power amplifier circuitry operable to amplify a set of output signals that collectively represents an amplified sample of an input signal having information. Further, the set of output signals is associated with a quantized polar representation of the sample of the input signal.

### FIELD OF THE DISCLOSURE

The present disclosure relates generally to amplifiers and more specifically to quantized amplification by a set of power amplifiers.

### BACKGROUND

Energy efficiency in telecommunications systems can be a key requirement in developing these systems. For instance, modern wideband communication systems employing modulation processes having high spectral efficiencies that are characterized by high envelope fluctuations and high peak-to-average power ratio (PAPR) can compromise the power amplification efficiency of radio frequency (RF) transceivers. High PAPR can also require power amplifiers (PAs) to have higher back-off from peak, which compromises the overall energy efficiency of those PAS. This is a common problem and limitation in modern wireless communication systems that adopt these modulation processes, such as orthogonal frequency-division multiplexing (OFDM), orthogonal frequency-division multiple access (OFDMA), single carrier with frequency equalization (SC-FDE), and Synthetic Aperture Radars (SARs), all of which can be characterized by wide bandwidths and high PAPR, which can compromise amplification efficiency. The Background section of this document is provided to place embodiments of the present disclosure in technological and operational context, to assist those of skill in the art in understanding their scope and utility. Unless explicitly identified as such, no statement herein is admitted to be prior art merely by its inclusion in the Background section.

### BRIEF SUMMARY OF THE DISCLOSURE

The following presents a simplified summary of the disclosure in order to provide a basic understanding to those of skill in the art. This summary is not an extensive overview of the disclosure and is not intended to identify key/critical elements of embodiments of the disclosure or to delineate the scope of the disclosure. The sole purpose of this summary is to present some concepts disclosed herein in a simplified form as a prelude to the more detailed description that is presented later.

Briefly described, embodiments of the present disclosure relate to systems and methods of performing quantized amplification by a set of power amplifiers. According to one aspect, an electronic device includes a set of power amplifier circuitry operable to collectively transmit an input signal having information and a circuitry electrically coupled to the set of power amplifier circuitry and operable to output a set of quantization components that collectively represents a sample of the input signal. Further, the set of quantization components corresponds to the set of power amplifier circuitry and is associated with a polar representation of the sample.

According to one aspect, an electronic device includes a set of power amplifier circuitry operable to transmit a set of output signals that collectively represents an amplified sample of an input signal having information. Further, each output signal is associated with a quantized polar representation of the sample.

According to one aspect, a method and apparatus for quantized amplification by a set of power amplifiers applies a first quantizer circuitry operable to obtain Nbq quantization bits, a second quantizer circuitry operable to quantize the quantization error, a mapper circuitry operable to map the quantization bits into Nba pairs of in-phase and quadrature-phase quantization components {s_{I,1}, s_{Q,1}; s_{I,2}, s_{Q2}; . . . ; s_{I,N}_{_{bq}}, d_{Q,N}_{_{bq}}} with different amplitudes {α₁=\sqrt{s_{I,1}²+s_{Q,1}²}; α₂=\sqrt{s_{I,2}²+s_{Q,2}²}; . . . ; α_{N}_{_{bq}}={square root over (s_{I,N}_{_{bq}}²+s_{Q,N}_{_{bq}}²)}} and operable to add the quantized quantization error or the quantization error to the components. Each pair of in-phase and quadrature-phase quantization components is summed and modulated by a quadrature-phase modulator circuitry operable to obtain N_{bq} intermediate frequency (IF) quantization components with constant envelope that are upconverted by N_{bq} mixer circuitry. The method and apparatus for digital to analog conversion with reduction or cancellation of quantization noise and optimization of energy efficiency may include a digitally controlled combiner circuitry with N_{bq} inputs or a set of N_{bq} amplifier circuitry digitally controlled followed by a digitally controlled combiner circuitry with N_{bq} inputs.

According to one aspect, the present disclosure relates to a digital to analog converter with partial or total cancellation of quantization error that converts each sample of the input signal into a set of N_{bq} constant envelope quantization components that when summed have a value that corresponds to the sample or with the quantization error minimized. The in-phase and quadrature-phase components of each quantization component can be summed and modulated by a quadrature-phase modulator circuitry to obtain N_{bq} IF bandpass components having constant envelope that are posteriorly upconverted to the RF frequency desired for the output signal. The quantization error en or the quantized quantization error e_{Qq} can be added to the quantization components to cancel or minimize the quantization error. By performing a weighted addition of the quantization error to the components, the value of the sum of the N_{bq} pairs of quantization components can correspond to the value of the sample and as such, the quantization noise is reduced or canceled. By performing a weighted addition of the quantized quantization error to the quantization components, the difference between the value of the sum of quantization components and the value of the sample is minimized, and the quantization noise is also minimized. The mapper circuitry is operable to also obtain digital control information that activates or deactivates pairs of in-phase and quadrature-phase quantization components according to the number of components that represent each sample value and can control in which quantization component the quantization noise is added. The mapper circuitry can also be operable to obtain digital control information to control the phases and amplitudes of quantization components to enable phase and time alignment of those components.

According to another aspect, the mapper circuitry can be operable to receive feedback control information from N_{bq} amplifier circuitry and from a combiner circuitry operable to obtain the digital control information that activates the inputs of the N_{bq} amplifier circuitry and that controls the phases or amplitudes of the quantization components to enable the outputs of the active amplifier circuitry to be phase or time aligned or the inputs of the combiner circuitry to be phase or time aligned.

According to another aspect, the mapper circuitry can be operable to receive feedback control information from a combiner circuitry with N_{bq} inputs to obtain the digital control information that activates or deactivates inputs of the combiner circuitry and to control the phases and amplitudes of quantization components to enable them to be combined in phase.

According to another aspect, the method and apparatus for quantized amplification by a set of power amplifiers can also include receiving as an input signal the samples of a baseband signal or the samples of a bandpass signal. It can also receive a clock signal according to the sampling frequency of the baseband or bandpass input signal, receive a clock signal according to the intermediate frequency, or receive a clock signal in accordance with the frequency of the desired RF output signal. In one example, this involves receiving a baseband signal and sampling it according to a reference clock signal having the sampling rate. In another example, this involves receiving a bandpass signal and sampling it according to a clock signal having the sampling rate.

Furthermore, each sample sn of a baseband input signal or sample sₙ of a bandpass input signal can be input to a quantizer circuitry that processes them to obtain the corresponding quantization bits representing the quantized value of each sample. The quantized value can be input to a quantization error obtain circuitry that also receives the sample to compute the value of the quantization error introduced during the quantization process. The quantization error e_{Q} can be received by a second quantizer circuitry that quantizes it to obtain a quantized error e_{Qq} and then can output it to a mapper circuit. The quantization performed by the second quantizer circuitry can be operable to recursively reduce the number of quantization bits to quantize the quantization error. The quantization bits together with the quantized quantization error can be input to the mapper circuitry that is operable to obtain a set of N_{bq} pairs of in-phase and quadrature-phase quantization components according to a binary mapping table that can be stored in a look up table (LUT) circuitry and can add the quantized quantization error to at least one of the quantization components. The mapper circuitry can also define the N′≤N_{bq} quantization components that should be active to represent the value of each sample.

In another embodiment, where the second quantizer circuitry is not used, the mapper circuitry can receive the quantization error e_{Q} that is added to the active pairs of in-phase and quadrature-phase components to reduce or cancel the quantization noise.

In another embodiment, the quantization error e_{Q} or the quantized quantization error e_{Qq} can be added to the smaller or smallest quantization component, can be added to the highest quantization component, or can be added to only one quantization component.

In another embodiment, the binary mapping table can also include the control information configured to activate or deactivate quantization components or time or phase corrections to enable the active components to be in phase or time aligned.

In accordance with the present concepts of the systems and techniques described herein, the method and apparatus for quantized amplification by a set of power amplifiers includes processing each one of the active pairs of in-phase and quadrature-phase quantization components in a mixer circuitry and a quadrature-phase modulator circuitry operable to obtain N′ active IF quantization components having constant envelope that are submitted to N′ mixer circuitry to upconvert and obtain N′ RF quantization components that, when summed, obtain an RF signal with the quantization noise reduced or canceled.

In one embodiment, the method and apparatus for quantized amplification by a set of power amplifiers includes N_{bq} stages with N_{bq} amplifier circuitry operating in parallel with N′ active amplifier circuitry having the N′ active RF quantization components as inputs and a digitally controlled combiner circuitry with N_{bq} inputs that combines the N′ active amplified RF quantization components. The mapper circuitry receives feedback information from a phase and driver signal amplifier controller circuitry and from the combiner circuitry operable to obtain the digital control information to activate and control the amplifier circuitry and inputs of the combiner circuitry and to assure that the inputs of the combiner circuitry are time and phase aligned, and the RF quantization components are combined in phase. When the quantization error is quantized, the N_{bq} power amplifier circuitry can be switched amplifiers, or the amplifier circuitry operable to amplify the smaller or smallest quantization component can be a current source amplifier and the other power amplifier circuitry can be switched amplifiers. When the quantization error is not quantized and added to the smaller or smallest quantization component, the amplifier circuitry can be of current source type and the other power amplifier circuitry can be switched amplifiers.

In another embodiment, the quantized amplification by a set of power amplifiers method and apparatus can include a digitally controlled combiner circuitry having up to N_{bq} inputs where N′ inputs can be active for each sample to combine the N′ active RF quantization components. The mapper circuitry can be operable to receive feedback information, and the combiner circuitry can be operable to obtain the digital control information to activate or control the inputs of the combiner circuitry and to enable the inputs of the combiner circuitry to be time and phase aligned so that the RF quantization components are combined in phase and time aligned.

In another embodiment, the method and apparatus for quantized amplification by a set of power amplifiers can include processing the N_{bq} quantization bits with the mapping function being performed in a circuitry operable to quantize, map, or compensate the quantization error and to obtain the digital control information to enable quantization components, amplifiers and assure that inputs of the combiner circuitry are time or phase aligned.

In one embodiment, the method and apparatus for quantized amplification by a set of power amplifiers includes a mapper circuitry operable to map the quantization bits into the set of active pairs of in-phase and quadrature-phase quantization components, add the quantization error to at least one of the active components and to sum the components to obtain a unique component that is submitted to a mixer circuitry and a quadrature-phase modulator circuitry operable to obtain the analog signal at the IF frequency. In this embodiment, only a single mixer circuitry can be included to upconvert to the desired frequency of the output signal and without having to include a combiner circuit.

In another embodiment, the mixer circuitry and the quadrature-phase modulator circuitry can be replaced by an in-phase and quadrature-phase digital to analog converter (DAC) circuit.

In accordance with the present concepts of the systems and techniques described herein, the digital control information can include digital control information obtained by the mapper circuitry and the digital control information of the phase and drive signal amplifier controller circuitry operable to change the phases of the input signals to enable all signals to be combined in phase. The mapper circuitry can be operable to correct the phases of the quantization components according to the feedback information provided by the digital combiner controller circuitry or feedback information about the phases of the PA circuitry output to enable the quantization components to be combined in phase.

In another embodiment, a digital phase and drive signal amplifier controller circuitry can be operable to change the phases of the PA circuit's input signals and can drive conditions according to the information provided by the digital combiner circuitry and feedback information related to the phases and power of the PA circuitry outputs.

Embodiments of this disclosure can be implemented with analog control, digital control, or both. The embodiments of this disclosure can be implemented with analog components or with a combination of analog components and digital components.

### BRIEF DESCRIPTION OF THE DRAWINGS

The present disclosure will now be described more fully hereinafter with reference to the accompanying drawings, in which embodiments of the disclosure are shown. However, this disclosure should not be construed as limited to the embodiments set forth herein. Rather, these embodiments are provided so that this disclosure will be thorough and complete, and will fully convey the scope of the disclosure to those skilled in the art. Like numbers refer to like elements throughout.

FIGS. 1A-1B illustrate one embodiment of a method of performing quantized amplification by a set of power amplifiers in accordance with various aspects as described herein.

FIGS. 2A-2B illustrate embodiments of a system of performing quantized amplification by a set of power amplifiers according to various aspects as described herein.

FIG. 3 illustrates one embodiment of the first circuitry 215 of FIGS. 2A-2B in accordance with various aspects as described herein.

FIG. 4 illustrates another embodiment of the first circuitry 215 of FIGS. 2A-2B in accordance with various aspects as described herein.

FIG. 5 illustrates one embodiment of a wireless communication network in accordance with various aspects as described herein.

FIG. 6 illustrates one embodiment of an electronic device in accordance with various aspects as described herein.

### DETAILED DESCRIPTION

For simplicity and illustrative purposes, the present disclosure is described by referring mainly to exemplary embodiments thereof. In the following description, numerous specific details are set forth in order to provide a thorough understanding of the present disclosure. However, it will be readily apparent to one of ordinary skill in the art that the present disclosure may be practiced without limitation to these specific details.

In the present disclosure, modulated bandpass signals can be described for each symbol interval Tₛ by s(t)=s_{I}(t)cos(ω_{c}t)−s_{Q}(t)sin(ω_{c}t), where ω_{c}=2πf_{c} denotes the angular frequency, f_{c} denotes the carrier frequency, and s_{I}(t) and s_{Q}(t) denote the respective in-phase and the quadrature-phase components. The signal can also be described in terms of its complex envelope or baseband version by s(t)=Re{\tilde{s}(t)e^{jω}^{_{c}}^{t}}, where \tilde{s}(t)=s_{I}(t)+js_{Q}(t) denotes the complex envelope, with the signal envelope given by env(t)={square root over ((s_{I})(t))²+(s_{Q}(t))²)} and the phase given by α(t)=arctan(s_{Q}(t)/s_{I}(t)), where arctan denotes the arc tangent function. When these signals are sampled at a sampling instant tₙ results for the bandpass signal the sample sₙ=s(tₙ)=s_{I}(tₙ)cos(ω_{c}tₙ)−s_{Q}(tₙ)sin(ω_{c}tₙ) and for a bandpass at IF results in the sample sₙ=s(tₙ)=s_{I}(tₙ)cos(2πfᵢtₙ)−s_{Q}(tₙ)sin(2πfᵢtₙ), where fᵢ denotes the IF frequency. For the baseband signal results, \tilde{s}ₙ=\tilde{s}(tₙ)=s_{I}(tₙ)+js_{Q}(tₙ)=s_{In}+js_{Qn}, where s_{In} and s_{Qn} represent the sample of the respective in-phase and quadrature-phase components. The corresponding sample of the envelope is envₙ=env(tₙ)=\sqrt{(s_{In})²+(s_{Qn})²} with a phase given by αₙ=α(tₙ)=arctan (s_{Qn}/s_{In}). When env(t) is constant or quasi-constant along time, a signal is said to be a constant envelope signal. Time-varying envelope signal refers to a signal where env(t) shows amplitude variations with time. Having both non-constant envelope and phase, s(t) is said to be a time-varying complex envelope signal. The dynamic range (DR) of the envelope represents the range of values between the signal's envelope (may assume any value between the envelope), which means that the number of possible values for the envelope can be infinite. These variations lead to high PAPR, which can compromise the efficiency of a PA. Also, modern communication systems can use samples of the signal to be transmitted that are delivered to the transceiver stage, which means that those systems can include circuitry (e.g., DAC) to convert the digital information of the signal samples to the analog format in the transceiver, and that conversion can be performed with a reduction of the complexity and the approximation error. Thus, it can be a twofold problem where it can be more convenient to reduce the error and obtain a signal format that can enable peak energy efficiency if power amplification of the signal is performed. A quantizer circuitry can be included to reduce the number of possible values of the envelope and to reduce or cancel the quantization noise associated with the process so as not to impact the quality of the resulting signal.

In the present disclosure, through the quantization of the sample value envₙ using a quantizer circuitry with N_{QL}=2^{N}^{_{bq}} quantization levels, N_{bq} quantization bits and a quantization error e_{Q}=DR/2^{Nbq+1}, results in a quantized value env_{nq}=envₙ+_{Q} that can be mapped as a sum of quantization components, with each component being related to at least one of the quantization bits. In one example, each component is related to one of the quantization bits. The quantization bits of the quantized sample value env_{nq}, at the sampling instant tₙ, can be mapped into a set of discrete amplitudes related to pairs of in-phase and quadrature-phase quantization components having fixed amplitudes {s_{I,1}, s_{Q,1}; s_{I,2}, s_{Q,2}; . . . ; s_{I,Nbq}, s_{Q2,Nbq}}, which the sum differs from envₙ by e_{Q}. In each pair, the in-phase and quadrature-phase components can be summed and modulated by quadrature-phase modulator circuitry to obtain when combined an analog version of the signal. The amplitudes of pairs of in-phase and quadrature-phase quantization components {s_{I,1}, s_{Q,1}; s_{I,2}, s_{Q,2}; . . . ; s_{I,N}_{_{bq}}, s_{Q2,N}_{_{bq}}} can be represented as {α₁=\sqrt{s_{I,1}²+s_{Q,1}²}; α₂=\sqrt{s_{I,2}²+s_{Q,2}²}; . . . ; α_{N}_{_{bq}}={square root over (s_{I,N}_{_{bq}}²+s_{Q,N}_{_{bq}}²)}}. Since each bandpass version of each quantization component has constant envelope, the efficiency of the power amplification can be improved for the PAs employed in the power amplification of each component.

However, the quantization noise can still be a limitation introduced by the quantizer circuitry that can affect the spectrum or the performance of the resulting signal. Increasing the number of quantization bits can be a costly solution since it also increases the number of quantization components that represent each sample value and increases the hardware complexity. By computing the quantization error or quantizing it and adding it to one of the pairs of in-phase and quadrature-phase quantization components or by a weighted addition to the active components, it is possible to reduce or cancel the quantization error and minimize the quantization noise. The quantization can be done recursively to reduce the number of quantization bits that represent the quantization error. By adding the quantized quantization error e_{Qq} to the quantization components, the constant envelope condition stands. Further, since the possible amplitude values of each component still belong to a discrete alphabet, switched amplifiers can be included to improve the energy efficiency. In one example, one of the two smaller or smallest quantization components or the stronger or strongest quantization components can include the quantized quantization error e_{Qq}. In another example, any of the quantization components can include the quantized quantization error e_{Qq}. When the quantization noise is not quantized, it can be added to the smaller or smallest component that can be amplified by a current source power amplifier, while the other components can be amplified by switched amplifiers. Thus, in the present disclosure, a digital signal can be converted as a sum of a set of analog components having constant envelope with reduction or cancellation of quantization error, which enables the use of switched amplifiers to achieve peak energy efficiency when signal power amplification is also performed.

In modern transmission systems, the PA can represent the most power consuming device of an electronic device. This is the case for 4G and 5G base station transceivers under peak load, where the PA power consumption can represent more than 50% of the entire system's direct current (DC) power consumption. This also happens in satellite and Synthetic Aperture Radar (SAR) systems where the DC power consumption due to energy inefficiency of the PA limits the peak radiated power and consequently, the highest data rate achievable. This also creates heat problems together with increased system complexity in high power systems that work in back-off levels.

The present disclosure includes systems and methods of performing a digital to analog conversion with cancellation of quantization error. For example, a system can be operable to quantize and decompose an input signal to obtain a set of N_{bq} quantization components having constant amplitudes and can then determine the quantization error eo to enable determination of a weighted addition to an active set of N′≤N_{bq} quantization components to cancel the quantization error. In another example, an input signal can be quantized and decomposed into a set of N_{bq} quantization components having constant amplitudes, and the quantization error e_{Q} can be computed and quantized as e_{Qq} and can be added to one or more of the active quantization components to reduce the quantization error. In this system, the input signal can be a baseband signal or an IF bandpass signal that can be sampled. For example, the time samples \tilde{s}ₙ of a baseband signal or the samples sₙ of a bandpass signal can be received. In another example, the samples s_{In} and s_{Qn} of the in-phase and quadrature-phase components of a baseband signal can be received.

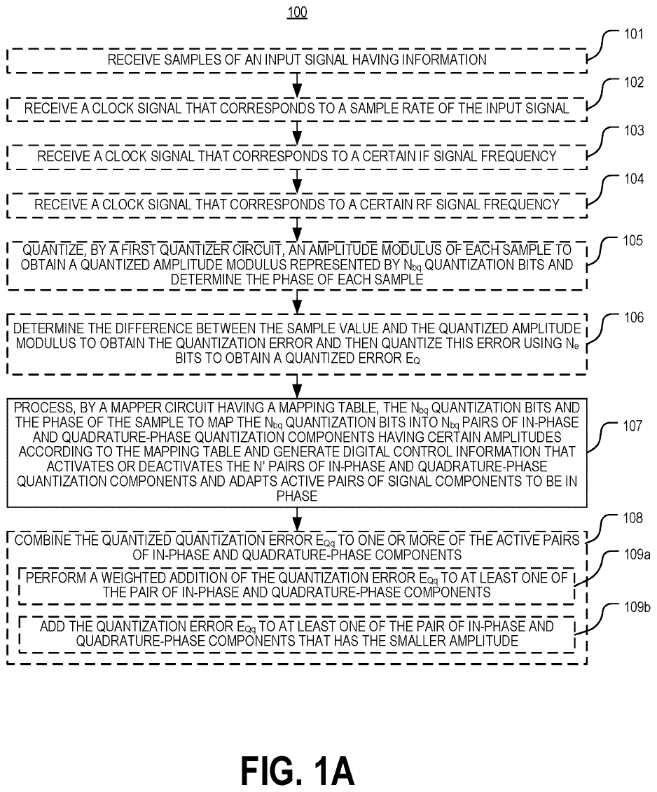

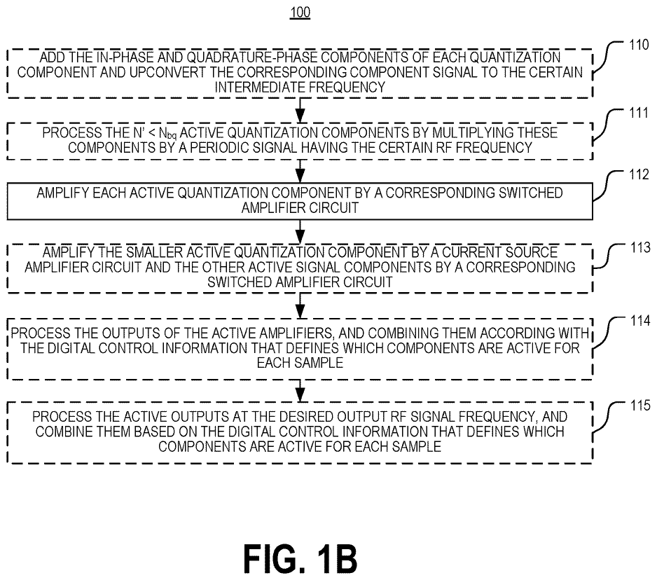

FIGS. 1A-1B illustrate one embodiment of a method 100 of performing quantized amplification by a set of power amplifiers according to various aspects as described herein. In FIG. 1A, the method 100 may start, for instance, at block 101 where it can include receiving samples of an input signal having information. For instance, the method 100 can include receiving a baseband signal or bandpass signal and sampling it in a sampling circuitry or a sample and hold (S/H) circuitry to obtain the samples of the input signal. At block 102, the method 100 can include receiving a clock signal that corresponds to a certain sample rate of the input signal. A skilled artisan will recognize that the sample rate may vary based on the bandwidth of the input signal, the desired time resolution of the sampling process, or the like. At block 103, the method 103 can include receiving a clock signal that corresponds to a certain intermediate frequency signal frequency. At block 104, the method 100 can include receiving a clock signal associated with a certain RF signal frequency. At block 105, the method 100 can include quantizing, by a first quantizer circuitry, the amplitude modulus (also referred to as amplitude) of each sample to obtain N_{bq} quantization bits representing the quantized amplitude modulus and can include determining the phase of each sample. At block 106, the method 100 can include determining, for each sample, the difference between the amplitude modulus and the quantized amplitude modulus of each sample to obtain the quantization error of the quantized amplitude modulus of that sample and can include quantizing, by a second quantizer circuitry, the quantization error of the quantized amplitude modulus with Nₑ bits representing this quantization error of each sample to obtain a quantized value of the quantization error of the quantized amplitude modulus of each sample. At block 107, the method 100 can include processing, by a mapper circuitry having a mapping table, both the N_{bq} quantization bits of the amplitude modulus and the phase of each sample output by the first quantizer circuitry to map the N_{bq} quantization bits representing the quantized value of the amplitude modulus of each sample into N_{bq} pairs of in-phase and quadrature-phase quantization components having different amplitudes and can include obtaining the digital control information configured to activate or deactivate the pairs of in-phase and quadrature-phase quantization components and to enable the active pairs of signal components to be in phase. The information associated with activation or deactivation of the set of in-phase and quadrature-phase quantization components can also be delivered to a signal amplifier controller or a digital controlled combiner to activate or deactivate drive signals. A skilled artisan will recognize that the steps of blocks 106 and 107 can be performed by a single circuitry that includes a comparator circuitry and a LUT circuitry with the corresponding bits and the discrete values of the amplitudes and the digital control signals that activate or deactivate the pairs of signal components. At block 108, the method 100 can include combining the quantized quantization error E_{Qq} to one or more of the active pairs of the in-phase and quadrature-phase components. In one example, method 100 can include performing a weighted addition of the quantization error E_{Qq} to at least one of the pair of in-phase and quadrature-phase components, as represented by block 109a. In another example, the method 100 can include adding the quantization error E_{Qq} to at least one of the pair of in-phase and quadrature-phase components that has the smaller or smallest amplitude, as represented by block 109b.

In FIG. 1B, the method 100 can include adding each pair of in-phase and quadrature-phase components and can include upconverting the corresponding component at the certain intermediate frequency, as represented by block 110. At block 111, the method 100 can include processing the N′≤N_{bq} active quantization components at the certain intermediate frequency by mixing or multiplying those active quantization components by a periodic pulse signal having a certain radio frequency of the output signal. At block 112, the method 100 can include collectively or individually amplifying, by switched amplifier circuitry, each one of the active quantization components. Additionally or alternatively, at block 113, the method 100 can include amplifying, by a current source amplifier circuitry, the quantization component having the smaller or smallest amplitude and can include amplifying, by switched amplifier circuitry, the other active quantization components. At block 114, the method 100 can include processing the amplified signals of the active amplifiers and can include combining, by a combiner circuitry, those signals based on the digital control information configured to define which signals are active for each sample in the power combination process. At block 115, the method 100 can include processing the active amplified signals at the certain RF signal frequency and can include combining those signals based on the digital control information configured to define which components are active or inactive for each sample.

In another embodiment, the successive samples of the input signal of a data block can be processed prior to the start of the quantization and quantization error compensation.

In another embodiment, the digital control information for activation or deactivation of components and compensation of quantization error can be obtained for an entire block of data.

In another embodiment, the mapper circuitry can be operable to map the quantization bits into the set of active pairs of in-phase and quadrature-phase quantization components, add the quantization error to one of the active components and sum the components to obtain a unique component that is submitted to a mixer circuitry and a quadrature-phase modulator circuitry to obtain the analog signal in the IF. In this embodiment, a mixer circuitry can be included to upconvert to the certain frequency of the output signal and no combiner circuitry is used.

In another embodiment, the mixer circuitry and the quadrature-phase modulator circuitry can be replaced by an in-phase and quadrature-phase digital to analog converter (I/Q DAC).

In another embodiment, the functions of quantization, mapping, activation or deactivation of components via digital control information and quantization error compensation are performed in a single circuit.

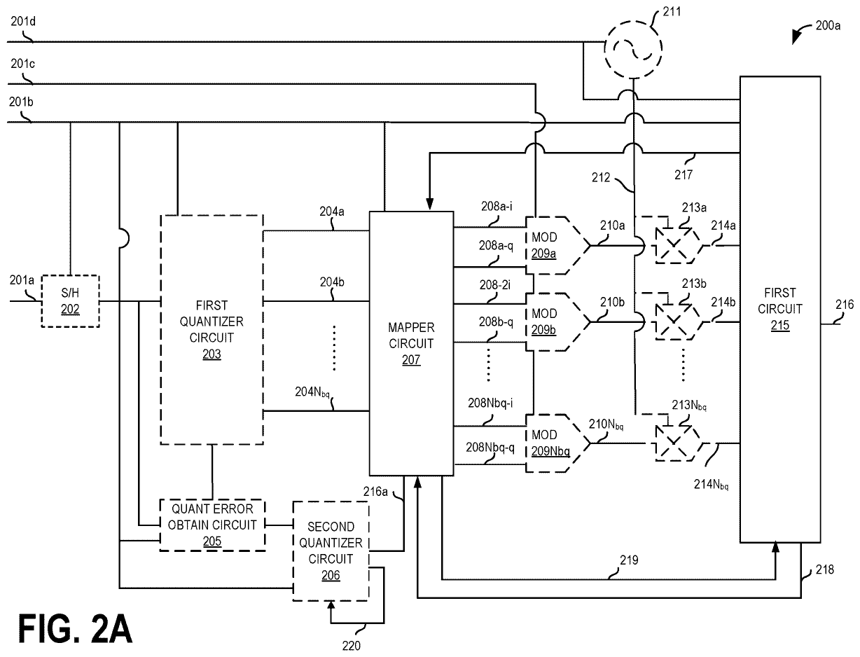

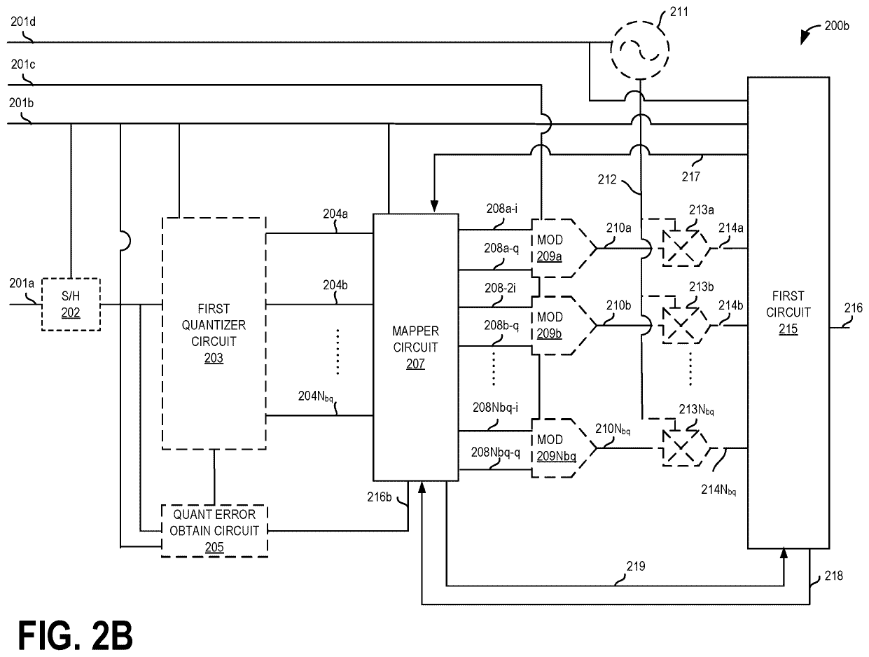

FIGS. 2A-2B illustrate embodiments of a system 200a, b of performing quantized amplification by a set of power amplifiers according to various aspects as described herein. In FIGS. 2A-2B, the system 200a,b can include a sample and hold circuitry 202 operable to sample and hold an input signal 201a to obtain a sample of the input signal 201a. The input signal 201a can be a baseband signal \tilde{s}(t), a bandpass signal s(t), or the like. In another embodiment, the sample and hold circuitry 202 can be operable to sample and hold the input signal 201a to obtain the samples s_{In} and s_{Qn} of the in-phase and quadrature-phase components of the input signal 201a. The system 200a,b can also receive a first reference clock signal 201b configured to represent the sampling frequency, a second reference clock signal 201c configured to represent a certain IF, a third reference clock signal 201d configured to represent a certain RF frequency of the output signal 216. A skilled artisan will readily recognize that the choice of the reference clock signals 201b-201d can be made according to the bandwidth of the input signal, the desired frequency of the input signal, the desired frequency of the output signal, or the like.

The scope of this disclosure includes the use of other reference clock signals and other input signals, and the implementation of such variations will be apparent to a skilled artisan based on the subject matter described herein.

In FIGS. 2A-2B, the first reference clock signal 201b can be input to the sample and hold circuitry 202, the first and second quantizer circuitry 203, 206, the quantization error obtain circuitry 205, the mapper circuitry 207, the quadrature modulator circuitry 209a-209N_{bq}, the mixer circuitry 213a-213N_{bq}, the control circuitry 215, or the like. In those embodiments that include the control circuitry 215, the first reference clock signal 201b can be a reference clock signal for a set of N_{bq} power amplifier circuitry and for a combiner circuit. The second reference clock signal 201c can be configured as a clock reference having a certain IF for the mixer circuitry 213a-213N_{bq} and the quadrature modulator circuitry 209a-209N_{bq}. The third reference clock signal 201d can be configured as a reference clock signal for the mixer circuitry 209a-209N_{bq} and for the control circuitry 215. In some embodiments that include the control circuitry 215, the third reference clock signal 201d can also be a reference clock signal having the RF frequency for a set of Nbq power amplifier circuitry. The first quantizer circuitry 203 can be operable to process the sample of the input signal 201a according to the first reference clock signal 201b to obtain a quantized sample value (envng) and the corresponding set of quantization bits 204a-204N_{bq}. The quantization error obtain circuitry 204 can be operable to receive, from the first quantizer circuitry 203, the quantized sample value and to receive, from the sample and hold circuitry 202, the sample value of the input signal 201a. The quantization error obtain circuitry 205 can then be operable to determine the modulus and the sign of the difference between the sample value and the quantized sample value. The quantization error obtain circuitry 205 can also be operable to output the quantization error value.

In FIG. 2A, the quantization error obtain circuitry 205 can be operable to receive, from the first quantizer circuitry 203, the quantized sample value and to receive, from the sample and hold circuitry 202, the sample value of the input signal 201a. The quantization error obtain circuitry 205 can then be operable to determine the amplitude modulus and the sign of the difference between the sample value and the quantized sample value. The quantization error obtain circuitry 205 can also be operable to output the quantization error value. The second quantizer circuitry 206 can be operable to receive and quantize the quantization error value to obtain a quantized quantization error 216a using Ne quantization bits. In one example, this quantization process can be performed recursively by feeding back the quantized value 220 and then quantizing that quantized value 220 again. The second quantizer circuitry 206 can then be operable to output, to the mapper circuitry 207, the quantized quantization error 216a. The mapper circuitry 207 can be operable to receive, from the first quantizer circuitry 203, the set of quantization bits 204a-204N_{bq} and receive, from the second quantizer circuitry 206, the quantized quantization error 216a to obtain the set of pairs of in-phase and quadrature-phase quantization components {s_{I,1}s_{Q,1}; s_{Q,2}; . . . s_{1,N}_{_{bq}}, s_{Q,N}_{_{bq}}} 208a-i to 208N_{bq-i}, 208a-q to 208N_{bq-q} having discrete values of amplitudes {α₁=\sqrt{s_{I,1}²s_{Q,1}²}; α₂=\sqrt{s_{I,2}²+s_{Q,2}²}; . . . ; α_{N}_{_{bq}}={square root over (s_{I,n}_{_{bq}}²+s_{Q}_{_{bq}}²)}}. The mapper circuitry 205 can be further operable to add the quantized quantization error 216a to the selected active pairs of quantization components to reduce the quantization noise of the first quantizer circuitry 203 and obtain digital control information 219 to activate or deactivate the pairs of quantization components that represent the quantized value of each sample of the input signal 201a. In one example, the mapper circuitry 207 can be operable to add the quantized quantization error 216a to one of the pair of in-phase and quadrature-phase quantization components that has the lower amplitude. In another example, the mapper circuitry 207 can be operable to add the quantized quantization error 216a to one of the pair of in-phase and quadrature-phase quantization components that has the higher or highest amplitude.

In FIG. 2B, the quantization error obtain circuitry 205 can be operable to receive, from the first quantizer circuitry 203, the quantized sample value and to receive, from the sample and hold circuitry 202, the sample value of the input signal 201a. The quantization error obtain circuitry 205 can then be operable to determine the amplitude modulus and the sign of the difference between the sample value and the quantized sample value. The quantization error obtain circuitry 205 can also be operable to output, to the mapper circuitry 207, the quantization error 216b. The mapper circuitry 207 can be operable to receive, from the first quantizer circuitry 203, the set of quantization bits 204a-204N_{bq} and receive, from the quantization error obtain circuitry 205, the quantization error 216b to obtain the set of pairs of in-phase and quadrature-phase quantization components {s_{I,1}, s_{Q,1}; s_{I,2}, s_{Q,2}; . . . ; s_{I,N}_{_{bq}}, s_{Q,N}_{_{bq}}} 208a-i to 208N_{bq-i}, 208a-q to 208N_{bq-q} having discrete values of amplitudes {α₁=\sqrt{s_{I,1}²+s_{Q,1}²}; α₂=\sqrt{s_{I,2}²+s_{Q,2}²}; . . . ; α_{N}_{_{bq}}={square root over (s_{I,N}_{_{bq}}²+s_{Q,N}_{_{bq}}²)}}. The mapper circuitry 207 can be further operable to add the quantization error 216b to the selected active pairs of quantization components to reduce the quantization noise of the first quantizer circuitry 203 and obtain digital control information 219 to activate or deactivate the pairs of quantization components that represent the quantized value of each sample of the input signal 201a. In one example, the mapper circuitry 207 can be operable to add the quantization error 216b to one of the pair of in-phase and quadrature-phase quantization components that has the lower or lowest amplitude. In another example, the mapper circuitry 207 can be operable to add the quantization error 216b to one of the pair of in-phase and quadrature-phase quantization components that has the higher amplitude.

In FIGS. 2A-2B, the mapper circuitry 207 can be configured to include a mapping table stored in a LUT circuitry having the quantization bits, with the corresponding set of amplitudes {s_{I,1}, s_{Q,1}; s_{I,2}, s_{Q,2}; . . . ; s_{I,N}_{_{bq}}, s_{Q,N}_{_{bq}}} to be applied to each pair of in-phase and quadrature-phase quantization components and the rule of quantization error cancellation. In another example, the mapper circuitry 207 can output both the binary mapping table and the digital control information to the control circuitry 215 operable to obtain the digital control signals configured to activate or deactivate the outputs of N_{bq} power amplifier circuitry, activate or deactivate inputs of a combiner circuitry based on the binary mapping table and the digital control information. Each pair of in-phase and quadrature-phase quantization components 208a-i to 208N_{bq-i}, 208a-q to 208N_{bq-q} can be summed and modulated by quadrature modulator circuitry and corresponding mixer circuitry 209a-209N_{bq} to obtain the set of quantization components 210a-210N_{bq} at the IF signal frequency. The mixer circuitry 213a-213N_{bq} can be operable to mix the set of quantization components 210a-210N_{bq} at the IF signal frequency with a periodic signal 212 having a certain RF frequency for the output signal to obtain the set of quantization components 214a-214N_{bq} at the RF frequency. An oscillator circuitry 211 can be operable to generate the periodic signal 212 having the certain RF frequency based on the third reference clock signal 201d.

In another embodiment, the first and second reference clock signals 201b, 201c and digital control signal information 219 can be applied to ensure that the outputs of PAs can be time or frequency aligned. The first and second reference clock signals 201b, 201c and digital control signal information 219 can also be used by a digital phase and drive signal amplifier controller block in conjugation with feedback signals 217, 218 to correct phase mismatches at the outputs of the PAS.

In FIGS. 2A-2B, the digital control signal 219 can includes digital control configured to activate or deactivate the outputs 214a-214N_{bq} that are the inputs to the control circuitry 215, and the information related to the activated or deactivated mixers plus quadrature-phase modulators 209a-209N_{bq} for each sample of the input signal 201a and to control the activation or deactivation of the inputs of the control circuitry 215. The activation or deactivation of digital information can include information about the deactivated signals 214a-214N_{bq} that can be stored in a LUT circuit.

In another embodiment, the mapper circuitry 207 can be operable to map the quantization bits 204a-204N_{bq} to the set of active pairs of in-phase and quadrature-phase quantization components 208a-i to 208N_{bq-i}, 208a-q to 208N_{bq-q}, add the quantized quantization error 216a to one of the active components, and sum the active components among 208a-i to 208N_{bq-i}, 208a-q to 208N_{bq-q} to obtain a unique pair of in-phase and quadrature-phase quantization components that can be input to a mixer plus a quadrature-phase modulator circuitry to obtain the analog signal at IF signal frequency.

In another embodiment, the mapper circuitry 207 can be operable to map the quantization bits 204a-204N_{bq} to the set of active pairs of in-phase and quadrature-phase quantization components 208a-i to 208N_{bq-i}, 208a-q to 208N_{bq-q}, add the quantization error 216b to one of the active components, and sum the active components among 208a-i to 208N_{bq-i}, 208a-q to 208N_{bq-q} to obtain a unique pair of in-phase and quadrature-phase quantization components that can be input to a mixer plus a quadrature-phase modulator circuitry to obtain the analog signal at IF.

In another embodiment, the mixer and the quadrature-phase modulator circuitry 209a-209N_{bq} can be replaced by I/Q DACs.

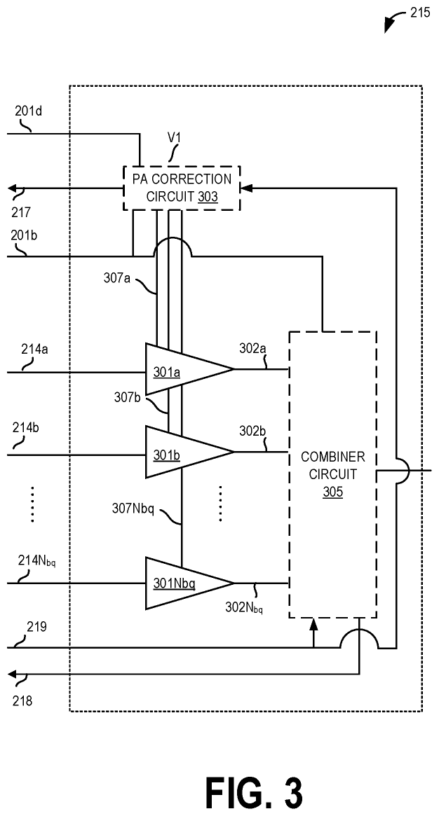

FIG. 3 illustrates one embodiment of the first circuitry 215 of FIGS. 2A-2B in accordance with various aspects as described herein. The first circuitry 215 can be configured to include PA circuitry 301a-301N_{bq}, a PA drive and phase correction circuitry 303, a combiner circuitry 305, or the like. Reference clock signals 201b, 201d can be inputs to the PA drive and phase correction circuitry 303 and can be input to the combiner circuitry 305. The PA drive and phase correction circuitry 303 can be operable to control the amplitude or phase of the PA circuitry 301a-301N_{bq} by a set of control signals 307a-307N_{bq} and according to the digital control information signal 219. Signals 214a-214N_{bq} can be the inputs to the set of amplifier circuitry 301a-301N_{bq} with the output 302a-302N_{bq} of each amplifier circuitry 301a-301N_{bq} being input to the combiner circuitry 305. The digital control information signal 219 can include digital control information configured to activate or deactivate the outputs of the amplifier circuitry 301a-301N_{bq}, or the phase or amplitude correction information to enable the activated signals among the set of signals 302a-302N_{bq} to be combined in phase. The PA circuitry 301a-301N_{bq} may be current source or switching PA circuitry, according to the requirements of the system.

In another embodiment, the PA circuitry 301a-301N_{bq} can be switched PAS.

In another embodiment, the PA circuitry 301a-301N_{bq} for the smaller or smallest quantization component can be a current source amplifier and the other PA circuitry 301a-301N_{bq} can be switched amplifiers. Both the power amplifier drive and phase correction block 303 and the combiner circuitry 305 can be operable to send respective feedback signals 217, 218 to the mapper circuitry 207 operable to correct amplitudes or phases to achieve time or phase alignment of the signals 302a-302N_{bq} that are combined by the combiner circuitry 305. The combiner circuitry 305 can be operable to output an amplified signal having the quantization error reduced or cancelled.

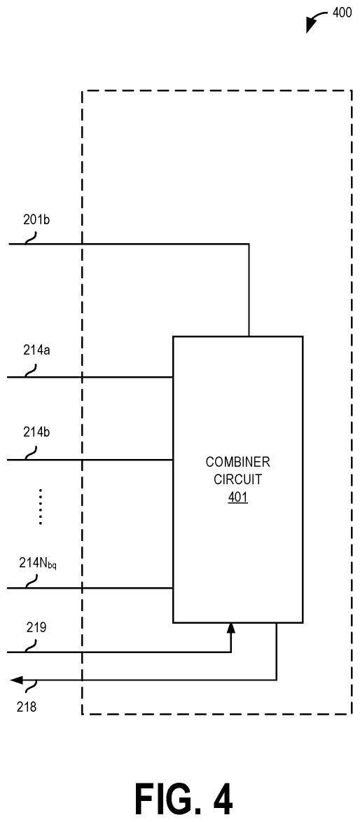

FIG. 4 illustrates another embodiment of the first circuitry 215 of FIGS. 2A-2B in accordance with various aspects as described herein. In FIG. 4, the first circuitry 215 can include a combiner circuitry 401 having N_{bq} inputs. Further, the combiner circuitry 401 can receive the clock reference signal 201b having the sampling frequency as well as the signals 214a-214N_{bq}. The input control signal 219 can include digital control information configured to activate or deactivate the input signals 210a-210N_{bq} of the combiner circuitry 401, and the information related to the phase or amplitude corrections to enable the activated signals among the set of signals 210a-210N_{bq} to be combined in phase. The combiner circuitry 401 can send feedback signals 218 to the mapper circuitry 207 so that this feedback information can correct amplitudes or phases to enable time or phase alignment of the signals that are combined by the combiner circuitry 401. The combiner circuitry 401 can output an output signal having a reduced or cancelled quantization error since the quantized quantization error was added to one of the signals 210a-210N_{bq}.

The scope of this disclosure includes the application of a circuitry or logic block that quantizes the samples of the input signal and quantizes the quantization error, obtains the quantization components and adds the quantization error or the quantized quantization error to the components, and implementations of such variations will be apparent to persons skilled in the art based on the teachings contained herein.

Furthermore, the blend of various techniques and circuitry provided in the disclosure provide aspects of this disclosure which enables reduced or cancelled quantization noise in the digital-to-analog conversion, increased energy efficiency, monolithic implementation and lower cost. Embodiments of this disclosure can be implemented by a blend of hardware, software and firmware. Both digital and analog techniques can be used with or without microprocessors, FPGA and DSP's.

Embodiments of this disclosure can be implemented for communications systems and electronics in general. In addition, and without limitation, mechanics, electro mechanics, electro optics, and fluid mechanics can make use of the same principles for efficiently quantization and decomposition of signals with minimization or total cancellation of quantization error.

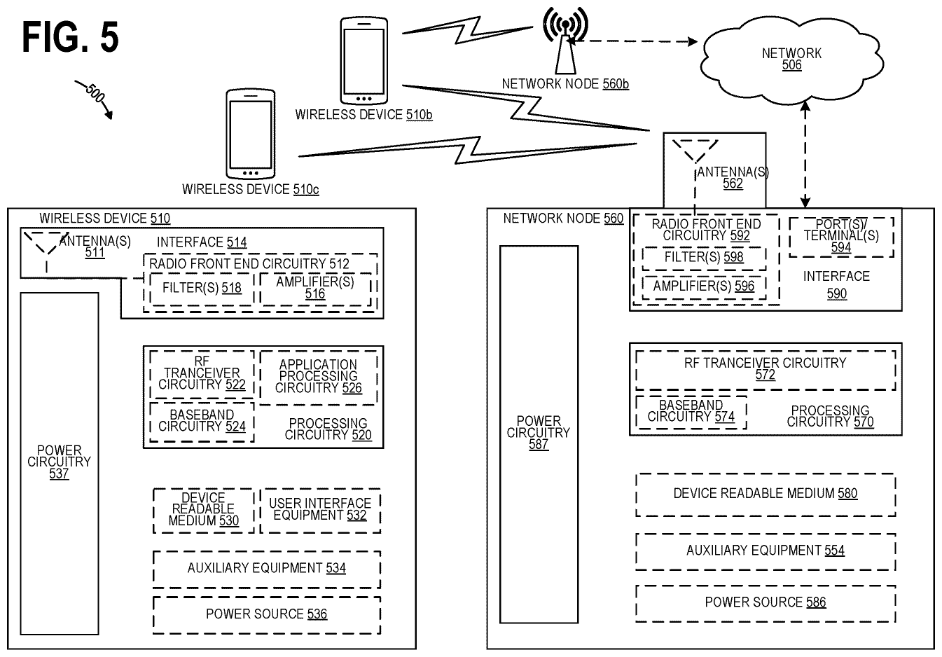

Although the subject matter described herein may be implemented in any appropriate type of system using any suitable components, the embodiments disclosed herein may also be described in relation to a wireless network, such as the example wireless network illustrated in FIG. 5. For simplicity, the wireless network of FIG. 5 only depicts network 506, network nodes 560 and 560b, and wireless devices 510, 510b, and 510c. In practice, a wireless network may further include any additional elements suitable to support communication between wireless devices or between a wireless device and another communication device, such as a landline telephone, a service provider, or any other network node or end device. Of the illustrated components, network node 560 and wireless device 510 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, 5G, 6G standards; wireless local area network (WLAN) standards, such as the IEEE 502.11 standards; and/or any other appropriate wireless communication standard, such as the Worldwide Interoperability for Microwave Access (WiMax), Bluetooth, Z-Wave and/or ZigBee standards.

Network 506 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 560 and wireless device 510 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs), and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 5, network node 560 includes processing circuitry 570, device readable medium 580, interface 590, auxiliary equipment 554, power source 556, power circuitry 557, and antenna 562.

Although network node 560 illustrated in the example wireless network of FIG. 5 may represent a device that includes the illustrated combination of hardware components, other embodiments may comprise network nodes with different combinations of components. It is to be understood that a network node comprises any suitable combination of hardware and/or software to perform the tasks, features, functions and methods disclosed herein. Moreover, while the components of network node 560 are depicted as single boxes located within a larger box, or nested within multiple boxes, in practice, a network node may comprise multiple different physical components that make up a single illustrated component (e.g., device readable medium 580 may comprise multiple separate hard drives as well as multiple random access memory (RAM) modules).

Similarly, network node 560 may be composed of multiple physically separate components (e.g., a NodeB component and a RNC component, or a BTS component and a BSC component, etc.), which may each have their own respective components. In certain scenarios in which network node 560 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 560 may be configured to support multiple radio access technologies (RATs). In such embodiments, some components may be duplicated (e.g., separate device readable medium 580 for the different RATs) and some components may be reused (e.g., the same antenna 562 may be shared by the RATs). Network node 560 may also include multiple sets of the various illustrated components for different wireless technologies integrated into network node 560, such as, for example, GSM, code division multiple access (CDMA), wideband CDMA (WCDMA), LTE, NR, Wi-Fi, or Bluetooth wireless technologies. These wireless technologies may be integrated into the same or different chip or set of chips and other components within network node 560.

Processing circuitry 570 is configured to perform any determining, calculating, or similar operations (e.g., certain obtaining operations) described herein as being provided by a network node. These operations performed by processing circuitry 570 may include processing information obtained by processing circuitry 570 by, for example, converting the obtained information into other information, comparing the obtained information or converted information to information stored in the network node, and/or performing one or more operations based on the obtained information or converted information, and as a result of said processing making a determination.

Processing circuitry 570 may comprise a combination of one or more of a microprocessor, controller, microcontroller, central processing unit, digital signal processor, application-specific integrated circuitry, field programmable gate array, or any other suitable computing device, resource, or combination of hardware, software and/or encoded logic operable to provide, either alone or in conjunction with other network node 560 components, such as device readable medium 580, network node 560 functionality. For example, processing circuitry 570 may execute instructions stored in device readable medium 580 or in memory within processing circuitry 570. Such functionality may include providing any of the various wireless features, functions, or benefits discussed herein. In some embodiments, processing circuitry 570 may include a system on a chip (SOC).

In some embodiments, processing circuitry 570 may include one or more of RF transceiver circuitry 572 and baseband processing circuitry 574. In some embodiments, RF transceiver circuitry 572 and baseband processing circuitry 574 may be on separate chips (or sets of chips), boards, or units, such as radio units and digital units. In alternative embodiments, part or all of RF transceiver circuitry 572 and baseband processing circuitry 574 may be on the same chip or set of chips, boards, or units. The embodiments described by this disclosure can be implemented for the network node 560 in the interface 590 and/or the processing circuitry 570. Further, the embodiments described by this disclosure can be implemented for the wireless device or user equipment 510 in the interface 514 and/or the processing circuitry 520.

In certain embodiments, some or all of the functionalities described herein as being provided by a network node, base station, eNB or other such network device may be performed by processing circuitry 570 executing instructions stored on device readable medium 580 or memory within processing circuitry 570. In alternative embodiments, some or all of the functionalities may be provided by processing circuitry 570 without executing instructions stored on a separate or discrete device readable medium, such as in a hard-wired manner. In any of those embodiments, whether executing instructions stored on a device readable storage medium or not, processing circuitry 570 may be configured to perform the described functionality. The benefits provided by such functionality are not limited to processing circuitry 570 alone or to other components of network node 560 but are enjoyed by network node 560 as a whole, and/or by end users and the wireless network generally.

Device readable medium 580 may comprise any form of volatile or non-volatile computer readable memory including, without limitation, persistent storage, solid-state memory, remotely mounted memory, magnetic media, optical media, RAM, read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 570. Device readable medium 580 may store any suitable instructions, data or information, including a computer program, software, an application including one or more of logic, rules, code, tables, etc. and/or other instructions capable of being executed by processing circuitry 570 and, utilized by network node 560. Device readable medium 580 may be used to store any calculations made by processing circuitry 570 and/or any data received via interface 590. In some embodiments, processing circuitry 570 and device readable medium 580 may be integrated.

Interface 590 is used in the wired or wireless communication of signaling and/or data between network node 560, network 506, and/or wireless devices 510,510b, 510c. As illustrated, interface 590 comprises port(s)/terminal(s) 594 to send and receive data, for example to and from network 506 over a wired connection. Interface 590 also includes radio front end circuitry 592 that may be coupled to, or in certain embodiments a part of, antenna 562. Radio front end circuitry 592 comprises filters 598 and amplifiers 596. Radio front end circuitry 592 may be connected to antenna 562 and processing circuitry 570. Radio front end circuitry may be configured to condition signals communicated between antenna 562 and processing circuitry 570. Radio front end circuitry 592 may receive digital data that is to be sent out to other network nodes or wireless devices via a wireless connection. Radio front end circuitry 592 may convert the digital data into a radio signal having the appropriate channel and bandwidth parameters using a combination of filters 598 and/or amplifiers 596. The radio signal may then be transmitted via antenna 562. Similarly, when receiving data, antenna 562 may collect radio signals which are then converted into digital data by radio front end circuitry 592. The digital data may be passed to processing circuitry 570. In other embodiments, the interface may comprise different components and/or different combinations of components.

In certain alternative embodiments, network node 560 may not include separate radio front end circuitry 592, instead, processing circuitry 570 may comprise radio front end circuitry and may be connected to antenna 562 without separate radio front end circuitry 592. Similarly, in some embodiments, all or some of RF transceiver circuitry 572 may be considered a part of interface 590. In still other embodiments, interface 590 may include one or more ports or terminals 594, radio front end circuitry 592, and RF transceiver circuitry 572, as part of a radio unit (not shown), and interface 590 may communicate with baseband processing circuitry 574, which is part of a digital unit (not shown).

Antenna 562 may include one or more antennas, or antenna arrays, configured to send and/or receive wireless signals. Antenna 562 may be coupled to radio front end circuitry 590 and may be any type of antenna capable of transmitting and receiving data and/or signals wirelessly. In some embodiments, antenna 562 may comprise one or more omni-directional, sector or panel antennas or reconfigurable intelligent surfaces (RIS) operable to transmit/receive radio signals between, for example, 2 GHz and 56 GHz. An omni-directional antenna may be used to transmit/receive radio signals in any direction, a sector antenna may be used to transmit/receive radio signals from devices within a particular area, and a panel antenna may be a line-of-sight antenna used to transmit/receive radio signals in a relatively straight line. In some instances, the use of more than one antenna may be referred to as multiple-input multiple-output (MIMO). In certain embodiments, antenna 562 may be separate from network node 560 and may be connectable to network node 560 through an interface or port.

Antenna 562, interface 590, and/or processing circuitry 570 may be configured to perform any receiving operations and/or certain obtaining operations described herein as being performed by a network node. Any information, data and/or signals may be received from a wireless device, another network node and/or any other network equipment. Similarly, antenna 562, interface 590, and/or processing circuitry 570 may be configured to perform any transmitting operations described herein as being performed by a network node. Any information, data and/or signals may be transmitted to a wireless device, another network node and/or any other network equipment.

Power circuitry 587 may comprise, or be coupled to, power management circuitry and is configured to supply the components of network node 560 with power for performing the functionality described herein. Power circuitry 587 may receive power from power source 586. Power source 586 and/or power circuitry 587 may be configured to provide power to the various components of network node 560 in a form suitable for the respective components (e.g., at a voltage and current level for each respective component). Power source 586 may either be included in, or external to, power circuitry 587 and/or network node 560. For example, network node 560 may be connectable to an external power source (e.g., an electricity outlet) via an input circuitry or interface such as an electrical cable, whereby the external power source supplies power to power circuitry 587. As a further example, power source 586 may comprise a source of power in the form of a battery or battery pack which is connected to, or integrated in, power circuitry 587. The battery may provide backup power should the external power source fail. Other types of power sources, such as photovoltaic devices, may also be used.

Alternative embodiments of network node 560 may include additional components beyond those shown in FIG. 5 that may be responsible for providing certain aspects of the network node's functionality, including any of the functionality described herein and/or any functionality necessary to support the subject matter described herein. For example, network node 560 may include user interface equipment to allow input of information into network node 560 and to allow output of information from network node 560. This may allow a user to perform diagnostic, maintenance, repair, and other administrative functions for network node 560.

As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A wireless device may support device-to-device (D2D) communication, for example by implementing a 3rd Generation Partnership Project (3GPP) standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements and transmits the results of such monitoring and/or measurements to another wireless device and/or a network node. The wireless device may in this case be a machine-to-machine (M2M) device, which may in a 3GPP context be referred to as an MTC device. As one example, the wireless device may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 510 includes antenna 511, interface 514, processing circuitry 520, device readable medium 530, user interface equipment 532, auxiliary equipment 534, power source 536 and power circuitry 537. Wireless device 510 may include multiple sets of one or more of the illustrated components for different wireless technologies supported by wireless device 510, such as, for example, GSM, WCDMA, LTE, NR, Wi-Fi, WiMAX, NB-IoT, or Bluetooth wireless technologies, just to mention a few. These wireless technologies may be integrated into the same or different chips or set of chips as other components within wireless device 510.

Antenna 511 may include one or more antennas or antenna arrays, configured to send and/or receive wireless signals, and is connected to interface 514. In certain alternative embodiments, antenna 511 may be separate from wireless device 510 and be connectable to wireless device 510 through an interface or port. Antenna 511, interface 514, and/or processing circuitry 520 may be configured to perform any receiving or transmitting operations described herein as being performed by a wireless device. Any information, data and/or signals may be received from a network node and/or another wireless device. In some embodiments, radio front end circuitry and/or antenna 511 may be considered an interface.

As illustrated, interface 514 comprises radio front end circuitry 512 and antenna 511. Radio front end circuitry 512 comprise one or more filters 518 and amplifiers 516. Radio front end circuitry 512 is connected to antenna 511 and processing circuitry 520 and is configured to condition signals communicated between antenna 511 and processing circuitry 520. Radio front end circuitry 512 may be coupled to or a part of antenna 511. In some embodiments, wireless device 510 may not include separate radio front end circuitry 512; rather, processing circuitry 520 may comprise radio front end circuitry and may be connected to antenna 511. Similarly, in some embodiments, some or all of RF transceiver circuitry 522 may be considered a part of interface 514. Radio front end circuitry 512 may receive digital data that is to be sent out to other network nodes or wireless devices via a wireless connection. Radio front end circuitry 512 may convert the digital data into a radio signal having the appropriate channel and bandwidth parameters using a combination of filters 518 and/or amplifiers 516. The radio signal may then be transmitted via antenna 511. Similarly, when receiving data, antenna 511 may collect radio signals which are then converted into digital data by radio front end circuitry 512. The digital data may be passed to processing circuitry 520. In other embodiments, the interface may comprise different components and/or different combinations of components.

Processing circuitry 520 may comprise a combination of one or more of a microprocessor, controller, microcontroller, central processing unit, digital signal processor, application-specific integrated circuitry, field programmable gate array, or any other suitable computing device, resource, or combination of hardware, software, and/or encoded logic operable to provide, either alone or in conjunction with other wireless device 510 components, such as device readable medium 530, wireless device 510 functionality. Such functionality may include providing any of the various wireless features or benefits discussed herein. For example, processing circuitry 520 may execute instructions stored in device readable medium 530 or in memory within processing circuitry 520 to provide the functionality disclosed herein.

As illustrated, processing circuitry 520 includes one or more of RF transceiver circuitry 522, baseband processing circuitry 524, and application processing circuitry 526. In other embodiments, the processing circuitry may comprise different components and/or different combinations of components. In certain embodiments processing circuitry 520 of wireless device 510 may comprise a SOC. In some embodiments, RF transceiver circuitry 522, baseband processing circuitry 524, and application processing circuitry 526 may be on separate chips or sets of chips. In alternative embodiments, part or all of baseband processing circuitry 524 and application processing circuitry 526 may be combined into one chip or set of chips, and RF transceiver circuitry 522 may be on a separate chip or set of chips. In still alternative embodiments, part or all of RF transceiver circuitry 522 and baseband processing circuitry 524 may be on the same chip or set of chips, and application processing circuitry 526 may be on a separate chip or set of chips. In yet other alternative embodiments, part or all of RF transceiver circuitry 522, baseband processing circuitry 524, and application processing circuitry 526 may be combined in the same chip or set of chips. In some embodiments, RF transceiver circuitry 522 may be a part of interface 514. RF transceiver circuitry 522 may condition RF signals for processing circuitry 520.

In certain embodiments, some or all of the functionality described herein as being performed by a wireless device may be provided by processing circuitry 520 executing instructions stored on device readable medium 530, which in certain embodiments may be a computer-readable storage medium. In alternative embodiments, some or all of the functionalities may be provided by processing circuitry 520 without executing instructions stored on a separate or discrete device readable storage medium, such as in a hard-wired manner. In any of those embodiments, whether executing instructions stored on a device readable storage medium or not, processing circuitry 520 may be configured to perform the described functionality. The benefits provided by such functionality are not limited to processing circuitry 520 alone or to other components of wireless device but are enjoyed by wireless device 510 as a whole, and/or by end users and the wireless network generally.

Processing circuitry 520 may be configured to perform any determining, calculating, or similar operations (e.g., certain obtaining operations) described herein as being performed by a wireless device. These operations, as performed by processing circuitry 520, may include processing information obtained by processing circuitry 520 by, for example, converting the obtained information into other information, comparing the obtained information or converted information to information stored by wireless device 510, and/or performing one or more operations based on the obtained information or converted information, and as a result of said processing making a determination.

Device readable medium 530 may be operable to store a computer program, software, an application including one or more of logic, rules, code, tables, etc. and/or other instructions capable of being executed by processing circuitry 520. Device readable medium 530 may include computer memory (e.g., RAM or ROM), mass storage media (e.g., a hard disk), removable storage media (e.g., a CD or a DVD), and/or any other volatile or non-volatile, non-transitory device readable and/or computer executable memory devices that store information, data, and/or instructions that may be used by processing circuitry 520. In some embodiments, processing circuitry 520 and device readable medium 530 may be integrated.

User interface equipment 532 may provide components that allow for a human user to interact with wireless device 510. Such interaction may be of many forms, such as visual, audial, tactile, etc. User interface equipment 532 may be operable to produce output to the user and to allow the user to provide input to wireless device 510. The type of interaction may vary depending on the type of user interface equipment 532 installed in wireless device 510. For example, if wireless device 510 is a smart phone, the interaction may be via a touch screen; if wireless device 510 is a smart meter, the interaction may be through a screen that provides usage (e.g., the number of gallons used) or a speaker that provides an audible alert (e.g., if smoke is detected). User interface equipment 532 may include input interfaces, devices and circuitry, and output interfaces, devices and circuitry. User interface equipment 532 is configured to allow input of information into wireless device 510 and is connected to processing circuitry 520 to allow processing circuitry 520 to process the input information. User interface equipment 532 may include, for example, a microphone, a proximity or other sensor, keys/buttons, a touch display, one or more cameras, a USB port, or other input circuitry. User interface equipment 532 is also configured to allow output of information from wireless device 510, and to allow processing circuitry 520 to output information from wireless device 510. User interface equipment 532 may include, for example, a speaker, a display, vibrating circuitry, a USB port, a headphone interface, or other output circuitry. Using one or more input and output interfaces, devices, and circuitry, of user interface equipment 532, wireless device 510 may communicate with end users and/or the wireless network and allow them to benefit from the functionality described herein.

Auxiliary equipment 534 is operable to provide more specific functionality which may not be generally performed by wireless devices. This may comprise specialized sensors for performing measurements for various purposes, interfaces for additional types of communication such as wired communications etc. The inclusion and type of components of auxiliary equipment 534 may vary depending on the embodiment and/or scenario.

Power source 536 may, in some embodiments, be in the form of a battery or battery pack. Other types of power sources, such as an external power source (e.g., an electricity outlet), photovoltaic devices or power cells, may also be used. The wireless device 510 may further comprise power circuitry 537 for delivering power from power source 536 to the various parts of wireless device 510 which need power from power source 536 to carry out any functionality described or indicated herein. Power circuitry 537 may in certain embodiments comprise power management circuitry. Power circuitry 537 may additionally or alternatively be operable to receive power from an external power source; in which case wireless device 510 may be connectable to the external power source (such as an electricity outlet) via input circuitry or an interface such as an electrical power cable. Power circuitry 537 may also in certain embodiments be operable to deliver power from an external power source to power source 536. This may be, for example, for the charging of power source 536. Power circuitry 537 may perform any formatting, converting, or other modification to the power from power source 536 to make the power suitable for the respective components of wireless device 510 to which power is supplied.

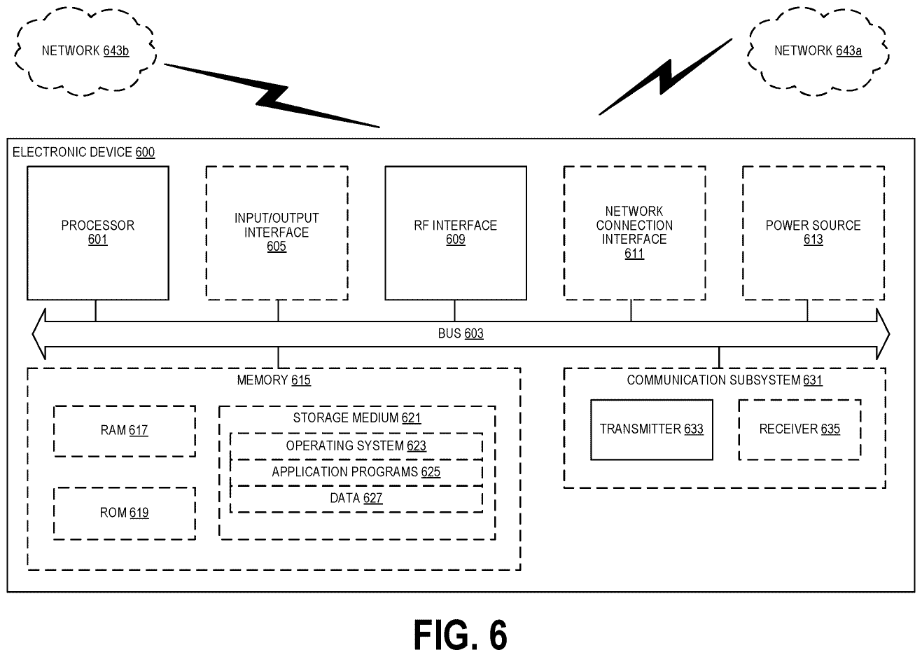

FIG. 6 illustrates one embodiment of an electronic device 600 in accordance with various aspects described herein. As used herein, device 600 can be a wired device, wireless device or both. Further, device 600 may not necessarily have a user in the sense of a human user who owns and/or operates the relevant device. Instead, device 600 may represent a device that is intended for sale to, or operation by, a human user but which may not, or which may not initially, be associated with a specific human user (e.g., a smart sprinkler controller, loT device). Alternatively, device 600 may represent a device that is not intended for sale to, or operation by, an end user but which may be associated with or operated for the benefit of a user (e.g., a smart power meter). Device 600 may be UE identified by the 3GPP, including a NB-IOT UE, a machine type communication (MTC) UE, and/or an enhanced MTC (eMTC) UE. Device 600, as illustrated in FIG. 6, is one example of a device configured for wired or wireless communication in accordance with one or more communication standards such as promulgated by the 3GPP, such as 3GPP's GSM, UMTS, LTE, and/or 5G standards.

Device 600 can include any electronic device that has an amplifier. In one example, device 600 can include an audio or music device, home audio system, stereo amplifier, audio or video receiver, home theater system, powered speaker, subwoofer, karaoke machine, musical equipment, guitar amplifier, bass amplifier, keyboard amplifier, public address system, studio monitor, headphone or earbud, noise-canceling headphone, portable audio device, Bluetooth speaker, portable amplifier for headphones or instrument, or the like. In another example, device 600 can include a wireless device, user equipment, network node, base station, broadcast or communication device, radio transmitter, wireless communication equipment, satellite communication system, Wi-Fi router, extended range device, telecommunication device, microwave repeater, radar system, or the like. In yet another example, device 600 can include consumer electronics, televisions, internal audio amplifier for a speaker, external soundbar with built-in amplifier, computer or gaming device, sound card with integrated amplifier, DAC with amplifier, smartphone, tablet, built-in audio amplifier for speaker or headphone, or the like. In yet another example, device 600 can include automotive or transportation device, car audio system, car amplifier, subwoofer amplifier, marine audio system, amplifier for boat or watercraft, aircraft communication system, amplifier for cockpit communication or in-flight entertainment, or the like. In yet another example, device 600 can include industrial and professional equipment, public address system, amplifier for a large venue, school or stadium, concert or event equipment, power amplifier for a loudspeaker, line array system, medical equipment, ultrasound machine, hearing aids, or the like. In yet another example, device 600 can include RF or specialized equipment, RF amplifier, signal booster for a cell tower, satellite uplink or downlink device, test or measurement instrument, oscilloscope, spectrum analyzer, military or aerospace equipment, radar system, communication jammer, or the like. In yet another example, device 600 can include toy or hobby device, radio-controlled car, plane or drone, smart home device, smart speaker, voice assistant device, or the like.

In FIG. 6, device 600 includes processing circuitry 601 that is operatively coupled to input/output interface 605, RF interface 609, network connection interface 611, memory 615 including RAM 617, ROM 619, and storage medium 621 or the like, communication subsystem 631, power source 613, and/or any other component, or any combination thereof. Storage medium 621 includes operating system 623, application program 625, and data 627. In other embodiments, storage medium 621 may include other similar types of information. Certain electronic devices may utilize all of the components shown in FIG. 6, or only a subset of the components. The level of integration between the components may vary from one device to another device. Further, certain electronic devices may contain multiple instances of a component, such as multiple processors, memories, transceivers, transmitters, receivers, etc.

In FIG. 6, processing circuitry 601 may be configured to process computer instructions and data. Processing circuitry 601 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or DSP, together with appropriate software; or any combination of the above. For example, the processing circuitry 601 may include two central processing units (CPUs). Data may be information in a form suitable for use by a computer.

In the depicted embodiment, input/output interface 605 may be configured to provide a communication interface to an input device, output device, or input and output device. Device 600 may be configured to use an output device via input/output interface 605. An output device may use the same type of interface port as an input device. For example, a USB port may be used to provide input to and output from device 600. The output device may be a speaker, a sound card, a video card, a display, a monitor, a printer, an actuator, an emitter, a smartcard, another output device, or any combination thereof. device 600 may be configured to use an input device via input/output interface 605 to allow a user to capture information into device 600. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, or an optical sensor.

In FIG. 6, RF interface 609 may be configured to provide a communication interface to RF components such as a transmitter, a receiver, and an antenna. Network connection interface 611 may be configured to provide a communication interface to network 643a. Network 643a may encompass wired and/or wireless networks such as a local-area network (LAN), a wide-area network (WAN), a computer network, a wireless network, a telecommunications network, another like network or any combination thereof. For example, network 643a may comprise a Wi-Fi network. Network connection interface 611 may be configured to include a receiver and a transmitter interface used to communicate with one or more other devices over a communication network according to one or more communication protocols, such as Ethernet, TCP/IP, synchronous optical networking (SONET), asynchronous transfer mode (ATM), or the like. Network connection interface 611 may implement receiver and transmitter functionality appropriate to the communication network links (e.g., optical, electrical, and the like). The transmitter and receiver functions may share circuitry components, software or firmware, or alternatively may be implemented separately.

RAM 617 may be configured to interface via bus 602 to processing circuitry 601 to provide storage or caching of data or computer instructions during the execution of software programs such as the operating system, application programs, and device drivers. ROM 619 may be configured to provide computer instructions or data to processing circuitry 601. For example, ROM 619 may be configured to store invariant low-level system code or data for basic system functions such as basic input and output (I/O), startup, or reception of keystrokes from a keyboard that are stored in a non-volatile memory. Storage medium 621 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 621 may be configured to include operating system 623, application program 625 such as a web browser application, a widget or gadget engine or another application, and data file 627. Storage medium 621 may store, for use by device 600, any of a variety of various operating systems or combinations of operating systems.

Storage medium 621 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 621 may allow device 600 to access computer-executable instructions, application programs or the like, stored on transitory or non-transitory memory media, to off-load data, or to upload data. An article of manufacture, such as one utilizing a communication system may be tangibly embodied in storage medium 621, which may comprise a device readable medium.

In FIG. 6, processing circuitry 601 may be configured to communicate with network 643b using communication subsystem 631. Network 643a and network 643b may be the same network or networks or different network or networks. Communication subsystem 631 may be configured to include one or more transceivers used to communicate with network 643b. For example, communication subsystem 631 may be configured to include one or more transceivers used to communicate with one or more remote transceivers of another device capable of wireless communication such as another electronic device, wireless device, UE, or base station of a radio access network (RAN) according to one or more communication protocols, such as IEEE 802.11, CDMA, WCDMA, GSM, LTE, UMTS Terrestrial Radio Access Network (UTRAN), WiMax, or the like. Each transceiver may include transmitter 633 and/or receiver 635 to implement transmitter or receiver functionality, respectively, appropriate to the RAN links (e.g., frequency allocations and the like). Further, transmitter 633 and receiver 635 of each transceiver may share circuitry components, software or firmware, or alternatively may be implemented separately.

In the illustrated embodiment, the communication functions of communication subsystem 631 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 631 may include cellular communication, Wi-Fi communication, Bluetooth communication, and GPS communication. Network 643b may encompass wired and/or wireless networks such as a LAN, a WAN, a computer network, a wireless network, a telecommunications network, another like network or any combination thereof. For example, network 643b may be a cellular network, a Wi-Fi network, and/or a near-field network. Power source 613 may be configured to provide alternating current (AC) or direct current (DC) power to components of device 600.

The features, benefits and/or functions described herein may be implemented in one of the components of device 600 or partitioned across multiple components of device 600. Further, the features, benefits, and/or functions described herein may be implemented in any combination of hardware, software or firmware. In one example, communication subsystem 631 may be configured to include any of the components described herein. Further, processing circuitry 601 may be configured to communicate with any of such components over bus 602. In another example, any of such components may be represented by program instructions stored in memory that when executed by processing circuitry 601 perform the corresponding functions described herein. In another example, the functionality of any of such components may be partitioned between processing circuitry 601 and communication subsystem 631. In another example, the non-computationally intensive functions of any of such components may be implemented in software or firmware and the computationally intensive functions may be implemented in hardware. The embodiments described by this disclosure can be implemented for the device 600 in the RF interface block 609 or the transmitter block 633 of the communication subsystem 631.

Those skilled in the art will also appreciate that embodiments herein further include corresponding computer programs.

A computer program comprises instructions which, when executed on at least one processor of an apparatus, cause the apparatus to carry out any of the respective processes described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts for illustrative purposes, but the embodiments are similarly applicable in other contexts not explicitly described.

In one exemplary embodiment, a method for quantized amplification by a set of power amplifiers can include receiving the samples \tilde{s}ₙ=\tilde{s}(tₙ)=s_{I}(tₙ)+js_{Q}(tₙ)=s_{In}+js_{Qn} of a baseband input signal \tilde{s}(t)=s_{I}(t)+js_{Q}(t), where s_{In} and s_{Qn} represent the sample of the in-phase and quadrature component respectively, and tn is the sampling instant. The method can further include receiving a clock signal in accordance with a sampling rate of the input signal, a clock signal according to an IF frequency, and a clock signal having an RF carrier frequency of the RF output signal. The method can also include computing the amplitude modulus envₙ=env(tₙ)=\sqrt{(s_{In})²+(s_{Qn})²} and the phase αₙ=α(tₙ)=arctan(s_{nQn}/s_{In}) of each sample. In addition, the method can include quantizing in a first quantizer circuitry, with N_{bq} quantization bits, the amplitude modulus envₙ of each sample to obtain the quantized value env_{ng} and the N_{bq} quantization bits and computing the phase of each sample. Further, the method can include determining, for each sample, the difference between the amplitude modulus envₙ of the sample and the quantized value env_{nq} to obtain the quantization error e_{Q} and quantizing the quantization error in a second quantizer circuitry with Ne bits to obtain a quantized quantization error e_{Qq} of the quantization error e_{Q}. The method can also include processing, by a mapper circuitry having a mapping table, the N_{bq} quantization bits of the first quantizer circuitry and the phase αₙ of each sample \tilde{s}ₙ to map the N_{bq} quantization bit into N_{bq} pairs of in-phase and quadrature-phase quantization components having different amplitudes according to the mapping table. The method can also include obtaining digital control information that activates or deactivates the pairs of in-phase and quadrature-phase quantization components so that all active pairs of signal components are in phase, with the digital information to change the amplitudes or phases of the quantization components. The method further includes adding the quantization error en or the quantized quantization error e_{Qq} to the active pairs of in-phase and quadrature quantization components. The method further includes adding the in phase and quadrature-phase components of each active quantization component and obtaining the corresponding component at the IF frequency. The method also includes multiplying the N′≤N_{bq} active quantization components at the IF frequency by a periodic pulse signal having the RF frequency to obtain N′ RF quantization components.

In another exemplary embodiment, the step of receiving the input signal can include receiving the samples \tilde{s}ₙ of a baseband signal \tilde{s}(t) and obtaining the samples s_{In} and s_{Qn} of the in-phase and quadrature components.

In another exemplary embodiment, the step of receiving the input signal can include receiving the samples of a bandpass signal sₙ=s(tₙ)=s_{I}(tₙ)cos(2πfᵢtₙ)−s_{Q}(tₙ)sin(2πfᵢtₙ), where fᵢ denotes the IF frequency and obtaining the samples s_{In} and s_{Qn} of the in-phase and quadrature-phase components.

In another exemplary embodiment, the second quantizer can include a recursive quantization process that feeds back the quantized value and quantizes it again several times.

In another exemplary embodiment, the mapper circuitry can be operable to process the N_{bq} quantization bits of first quantizer and the phase of each sample to map the N_{bq} quantization bit into N_{bq} using a mapping table with a set {s_{I,1}, s_{Q,1}; s_{I,2}, s_{Q,2}; . . . ; s_{I,N}_{_{bq}}, s_{Q2,N}_{_{bq}}} of values of pairs of in-phase and quadrature-phase quantization components with amplitudes {α₁=\sqrt{s_{I,1}²+s_{Q,1}²}; α₂=\sqrt{s_{I,2}²+s_{Q,2}²}; . . . ; α_{N}_{_{bq}}={square root over (s_{I,n}_{_{bq}}²+s_{Q,N}_{_{bq}}²)}}, to map the quantization bits into a set of pairs of in-phase and quadrature-phase quantization components with amplitudes {a₁; a₂; . . . ; a_{Nbq}} and weighted adding the quantized error e_{Qq} to the active pairs of quantization components, and determining digital control information to activate or deactivate the pairs of components that represent the quantized value of each sample \tilde{s}ₙ of the input signal.

In another exemplary embodiment, the mapping table can include several sets of discrete values of amplitudes {α₁=\sqrt{s_{I,1}²+s_{Q,1}²}; α₂=\sqrt{s_{I,2}²+s_{Q,2}²}; . . . ; α_{Nbq}={square root over (s_{I,N}_{_{bq}}²+s_{Q,N}_{_{bq}}²)}} and several sets of {s_{I,1}, s_{Q,1}; s_{I,2}, s_{Q,2}; . . . ; s_{I,N}_{_{bq}}, s_{Q,N}_{_{bq}}} of pairs of in-phase and quadrature quantization components.

In another exemplary embodiment, the step of adding the quantization error can include adding the quantization error e_{Q} or the quantized quantization error e_{Qq} to one of the pair of in-phase and quadrature quantization components that has the smaller or smallest amplitude.

In another exemplary embodiment, the step of adding the quantization error can include adding the quantization error e_{Q} or the quantized quantization error e_{Qq} to one active quantization component or weighted adding the quantization error e_{Q} or the quantized quantization error e_{Qq} to the active pairs of in-phase and quadrature-phase quantization components.

In another exemplary embodiment, the apparatus can include a set of N_{bq} switched power amplifiers where for each sample are N′≤N_{bq} active to individually amplify each one of the active RF quantization components. Further, the apparatus can include a combiner circuitry operable to process and combine the amplified RF quantization components that are output from the N′ active amplifiers based on the digital control information sent by the mapper circuitry that defines which RF quantization components are active in the power combination process.

In another exemplary embodiment, the apparatus can include a set of N_{bq}−1 switched power amplifier circuitry and one current source power amplifier circuitry to amplify the active RF quantization components, with the amplifier circuitry configured to amplify the RF quantization component having the smaller or smallest amplitude when it is active being a current source amplifier and the other active RF quantization components being amplified using the switched amplifier circuitry. Further, the apparatus can include a combiner circuitry operable to process and combine the amplified RF quantization components that are output from the N′ active amplifiers based on the digital control information sent by the mapper circuitry that defines which RF quantization components are active in the power combination process.

In another exemplary embodiment, the method can include processing the N′ active RF quantization components and combining them according to the digital control information that defines which components are active in the power combination process.

In another exemplary embodiment, the method can include said digital information about activation and deactivation of quantization components is delivered by the mapper to a digital drive and phase correction controller, that activates or deactivate drive signals, and to a digital controlled combiner.

In another exemplary embodiment, the method can include controlling the power supply voltage or the current to be applied to a plurality of power amplifier circuitry based on digital control information signals so that the output power of each power amplifier circuitry can be varied.

In another exemplary embodiment, the mapper can be operable to map the quantization bits to the set of active pairs of in-phase and quadrature quantization components, add the quantization error e_{Q} to one of the active components, and sum all the components to obtain a unique component that is submitted to a mixer circuitry or a quadrature modulator circuitry to obtain the analog signal at the IF frequency.

In one exemplary embodiment, an apparatus for quantized amplification by a set of power amplifiers can include a first input circuitry operable to receive the samples \tilde{s}ₙ=\tilde{s}(tₙ)=s_{I}(tₙ)+js_{Q}(tₙ)=s_{In}+js_{Qn} of a baseband input signal \tilde{s}(t)=s_{I}(t)+js_{Q}(t), where s_{In} and s_{Qn} represent the sample of the in-phase and quadrature component respectively, and tₙ is the sampling instant. Further, the apparatus can include a second input circuitry operable to receive a clock signal associated with a sampling rate of the input signal. The apparatus can also include a third input circuitry can be operable to receive a clock signal associated with an IF frequency. In addition, the apparatus can include a fourth input circuitry operable to receive a clock signal associated with a frequency of an output RF signal. The apparatus can further include a first quantizer circuitry operable to process the samples of the input signal \tilde{s}ₙ according to the reference clock signal associated with the sampling rate to obtain N_{bq} quantization bits for, computes the amplitude modulus envₙ=env(tₙ)=\sqrt{(s_{In})²+(s_{Qn})²} or the phase αₙ=α(tₙ)=arctan(s_{Qn}/s_{In}) of each sample, and obtains a quantized value env_{nq} of amplitude modulus envn of each sample \tilde{s}ₙ and the corresponding set of N_{bq} quantization bits. The apparatus can further include a second quantizer circuitry operable to receive the quantized value env_{nq}, the phase an and the sample value \tilde{s}ₙ and determine the modulus and the sign of the quantization error e_{Q}=envₙ−env_{nq}, which is quantized in the second quantizer circuitry with Nₑ quantization bits to obtain the quantized error e_{Qq} of the quantization error e_{Q}. The apparatus can also include a mapper circuitry having a mapping table with the set {s_{I,1}, s_{Q,1}; s_{I,2}, s_{Q,2}; . . . ; s_{I,N}_{_{bq}}, s_{Q,N}_{_{bq}}} of in-phase and quadrature-phase quantization components with discrete values of amplitudes {α₁=\sqrt{s_{I,1}²+s_{Q,1}²}; α₂=\sqrt{s_{I,2}²+s_{Q,2}²}; . . . ; α_{Nbq}={square root over (s_{I,N}_{_{bq}}²+s_{Q,N}_{_{bq}}²)}}. Further, the mapper circuitry can be operable to receive the quantization bits of the quantized sampled value env_{ng}, map these bits to a set of pairs of in-phase and quadrature-phase quantization components having values {s_{I,1}, s_{Q,1}; s_{I,2}, s_{Q,2}; . . . ; s_{I,N}_{_{bq}}, s_{Q,N}_{_{bq}}}, and add the quantized error e_{Qq} to the active pairs of quantization components, and obtain digital control information to activate or deactivate the pairs of components that represent the quantized value of each sample \tilde{s}ₙ of the input signal. The apparatus can further include N_{bq} quadrature modulator and mixer circuitry operable to sum and modulate each one of the N′≤N_{bq} active pairs of in-phase and quadrature quantization components of the set {s_{I,1}, s_{Q,1}; s_{I,2}, s_{Q,2}; . . . ; s_{I,N}_{_{bq}}, s_{Q,N}_{_{bq}}} to obtain a set of N′≤N_{bq} IF quantization components. In addition, the apparatus can include mixer circuitry operable to multiply each IF quantization component by a periodic signal having the certain RF frequency for the output signal to obtain the RF quantization components.

In another exemplary embodiment, the input signal can be a baseband signal \tilde{s}(t) or a bandpass signal s(t) that is sampled by a sampling circuitry to obtain the in-phase and quadrature-phase samples s_{In} and s_{Qn}.

In another exemplary embodiment, the input signal can include the samples s_{In} and s_{Qn} of the in-phase and quadrature-phase components of a baseband signal.

In another exemplary embodiment, the mapper circuitry can be operable to add the quantized quantization error e_{Qq} or the quantization error e_{Q} to the pair of in-phase and quadrature quantization components having the smaller or smallest amplitude. The mapper circuitry can be configured to include a binary mapping table that may be stored in a LUT with the quantization bits, with the corresponding set {s_{I,1}, s_{Q,1}; s_{I,2}, s_{Q,2}; . . . ; s_{I,N}_{_{bq}}, s_{Q,N}_{_{bq}}} in-phase and quadrature quantization components and with the rule of quantization error cancellation.

In another exemplary embodiment, the mapper circuitry can be operable to perform a weighted addition of the quantized quantization error e_{Qq} or weighted addition of the quantization error e_{Q} to the active pairs of in-phase and quadrature quantization components. Further, the mapper circuitry can be configured to include a binary mapping table that may be stored in a LUT circuitry with the quantization bits, with the corresponding set {s_{I,1}, s_{Q,1}; s_{I,2}, s_{Q,2}; . . . ; s_{I,N}_{_{bq}}, s_{Q,N}_{_{bq}}} of in-phase and quadrature quantization components and the rule of quantization error cancellation.

In another exemplary embodiment, the mixer and quadrature modulator circuitry can be replaced by in-phase/quadrature-phase DAC circuitry.

In another exemplary embodiment, the quadrature modulators can be replaced by in-phase/quadrature-phase DAC circuitry.

In another exemplary embodiment, the functions of the first quantizer circuitry and the functions of the mapper circuitry can be implemented by any combination of hardware, software and firmware, including both digital and analog techniques with or without microprocessors, FPGAs and DSPs.

In another exemplary embodiment, the mapper circuitry can be operable to map the quantization bits to the set of active pairs of in-phase and quadrature-phase quantization components, add the quantization error to one of the active components, and sum the components to obtain a unique component configured to be input to the mixer and the quadrature modulator circuitry to obtain the analog signal at the IF frequency.

In another exemplary embodiment, the mapper circuitry can be operable to provide the digital control information with the digital control signals configured to activate or deactivate the amplifier circuitry, the quadrature modulator circuitry, the mixer circuitry, or the inputs to the combiner circuit.

In another exemplary embodiment, the second quantizer circuitry can be operable to perform a recursive quantization process that feeds back the quantized value and quantizes it multiple times.

In another exemplary embodiment, the apparatus can include a first circuitry having a plurality of PA circuitry, which may be switched PA circuitry, current source PA circuitry, or any combination thereof. Further, the first circuitry can be operable to receive the set of active RF quantization components and amplify each one using N′ PA circuitry among the set of PA circuitry to obtain the amplified RF quantization components that are the inputs to a combiner circuit. The first circuitry can also include a PA drive and phase correction circuitry operable to receive the reference clock signal having the sampling frequency of the input signal, the reference clock signal having the RF of the output signal, the binary mapping table, and the digital control information used to activate or deactivate the outputs of the PA circuitry and the control information configured to enable phase or amplitude corrections so that the activated signals can be combined in phase, control the amplitude or phase of the different PA circuitry by a plurality of control signals and according the digital control information used to activate or deactivate the outputs of the PA circuitry, and providing the phase and amplitude correction information to enable the activated signals among the set of signals to be combined in phase. Further, the combiner circuitry can be operable to receive the mapping table from the mapper circuitry and the amplified RF quantization components and combines in phase the components according to the digital control information configured to enable the activated signals of the set of signals to be combined in phase. In addition, the PA drive and phase correction circuitry and the combiner circuitry can be operable to send feedback signals to the mapper circuitry operable to update the digital control information with updated amplitudes or phases to achieve time or phase alignment of the signals that are combined based on the feedback signals. The first circuitry can also be operable to receive clock signals with the sampling frequency and the RF frequency for the output signal and the digital control signal information from the mapper circuitry that are used to ensure that the outputs of the PA circuitry are time or frequency aligned, and where these signals are used in conjugation with feedback signals to change phases of the outputs of the PA circuitry to enable the amplified RF quantization components to be time or phase aligned, and to ensure that the outputs of all active PA circuitry are time or frequency aligned and to correct phase mismatches and amplitudes at the PA circuitry outputs. The first circuitry can also include a block circuitry operable to control the amplitude or phase of the different PA circuitry and the combiner circuitry operable to receive digital control information from the mapper circuitry with the digital control signals to activate or deactivate the outputs of PA circuitry and to activate or deactivate the inputs of the combiner circuit.

In another exemplary embodiment, the first circuitry can include the combiner circuitry operable to receive a plurality of quantization components in the RF frequency, the reference clock signal with the reference for the sampling frequency, the digital control information used to activate or deactivate the inputs of the combiner, and the information about the phase and amplitude corrections to assure that the activated quantization components in the RF frequency are combined in phase. Further, the combiner circuitry can be operable to determine feedback signals sent to the mapper circuitry that uses this information to correct the information about the phase or amplitude to achieve time or phase alignment of the quantization components in the RF frequency that are combined in the combiner circuitry.

In another exemplary embodiment, a bandpass filter can be coupled to each amplifier to filter each signal according to the desired spectral mask for the output signal.

In another exemplary embodiment, the mapper circuitry, the first and second quantizer circuitry, and the mixer and quadrature modulator circuitry can be implemented by any combination of hardware, software and firmware, including both digital and analog techniques with or without microprocessors, FPGAs and DSPs.

In one exemplary embodiment, a method is performed by an electronic device having a set of power amplifier circuitry operable to collectively amplify an input signal carrying information. Further, the method includes outputting a set of quantization components that collectively represents a sample of the input signal with at least one of those components being modified to reduce a quantization error associated with the input sample. Further, each component corresponds to one of the set of power amplifier circuitry, one of a set of quantization bits that represents a quantized amplitude of a polar representation of the input sample, and a phase of the polar representation of the input sample.

In another exemplary embodiment, the method can further include obtaining pairs of in-phase and quadrature-phase quantized components that collectively represent the input sample. Further, each pair can correspond to one of the set of power amplifier circuitry, one of the set of quantization bits that represents the quantized amplitude, and the phase of the polar representation of the sample. Also, at least one of the pairs can be modified to reduce the quantization error associated with the input sample. The method can further include combining the in-phase and quadrature-phase quantized components of each pair to obtain the set of quantization components.

In another exemplary embodiment, the method can include modifying the at least one of the pairs based on the quantized quantization error associated with the input sample.

In another exemplary embodiment, the modifying step can further include combining the at least one of the pairs and the quantized quantization error associated with the input sample.

In another exemplary embodiment, the modifying step can further includes combining the quantized quantization error associated with the input sample to one of the pair of in-phase and quadrature-phase components that corresponds to a least significant bit of the set of quantization bits that represents the quantized amplitude of the polar representation of the input sample.

In another exemplary embodiment, the modifying step can further include applying a weighting factor to the quantized quantization error associated with the input sample.

In another exemplary embodiment, the method can further include receiving the input signal and quantizing the input signal to obtain the input sample.

In another exemplary embodiment, the method can further include determining the amplitude and the phase of the polar representation of the input sample and quantizing, by a first quantizer circuitry, the amplitude of the polar representation of the input sample to obtain the set of quantization bits that represents the quantized amplitude of the polar representation of the input sample.

In another exemplary embodiment, the method can include determining a difference between the amplitude of the polar representation of the input sample and the quantized amplitude of the polar representation of the input sample to obtain the quantization error associated with the input sample.

In another exemplary embodiment, the method can include quantizing, by a second quantizer circuitry, the quantization error associated with the input sample to obtain a quantized quantization error associated with the input sample.

In another exemplary embodiment, each power amplifier circuitry can be operable to amplify one of the set of quantization components that is modified to reduce the quantization error associated with the input sample is configured as a current source amplifier circuit.

In another exemplary embodiment, each power amplifier circuitry can be operable to amplify one of the set of quantization components that is unmodified to reduce the quantization error associated with the input sample is configured as a switched amplifier circuit.

In another exemplary embodiment, the power amplifier circuitry can be operable to amplify the quantization component that corresponds to a least significant bit of the set of quantization bits that represents the quantized amplitude of the polar representation of the sample is configured as a current source amplifier circuit.

In another exemplary embodiment, the power amplifier circuitry can be operable to amplify the quantization component that corresponds to a non-least significant bit of the set of quantization bits that represents the quantized amplitude of the polar representation of the sample is configured as a current source amplifier circuit.

In one exemplary embodiment, an electronic device includes a set of power amplifier circuitry operable to collectively amplify an input signal carrying information. Further, the electronic device includes a mapper circuitry operable to output a set of quantization components that collectively represent a sample of the input signal with at least one of those components being modified to reduce a quantization error associated with the input sample. Further, each component corresponds to one of the set of power amplifier circuitry, one of a set of quantization bits that represents a quantized amplitude of a polar representation of the input sample, and a phase of the polar representation of the input sample.

In another exemplary embodiment, the mapper circuitry can be further operable to obtain pairs of in-phase and quadrature-phase quantized components that collectively represent the input sample.

Further, each pair can correspond to one of the set of power amplifier circuitry, one of the set of quantization bits that represents the quantized amplitude of the polar representation of the input sample and the phase of the polar representation of the input sample. In addition, at least one of the pairs can be modified to reduce the quantization error associated with the input sample.

In another exemplary embodiment, the electronic device can further include a set of quadrature modulator circuitry operable to combine the in-phase and quadrature-phase quantized components of the pairs to obtain the set of quantization components.

In another exemplary embodiment, the electronic device can further include a first quantizer circuitry operable to obtain the amplitude and the phase of the polar representation of the input sample and quantize the amplitude of the polar representation of the input sample to obtain the quantized amplitude of the polar representation of the input sample. The electronic device can further include a quantization error determination circuitry operable to determine a difference between the amplitude of the polar representation of the input sample and the quantized amplitude of the polar representation of the input sample to obtain the quantization error associated with the input sample. The electronic device can further include a second quantizer circuitry operable to quantize the quantization error to obtain a quantized quantization error associated with the input sample. The electronic device can further include a mapper circuitry operable to modify at least one of the pairs based on the quantized quantization error associated with the input sample.

In one exemplary embodiment, an electronic device includes a set of power amplifier circuitry operable to collectively amplify an input signal carrying information. The electronic device further includes a first quantizer circuitry operable to obtain an amplitude and a phase of a polar representation of a sample of the input signal and quantize the amplitude of the polar representation of the input sample to obtain the quantized amplitude of the polar representation of the input sample. The electronic device further includes a quantization error determination circuitry operable to determine a difference between the amplitude of the polar representation of the input sample and the quantized amplitude of the polar representation of the input sample to obtain the quantization error associated with the input sample. The electronic device further includes a second quantizer circuitry operable to quantize the quantization error to obtain a quantized quantization error associated with the input sample. The electronic device further includes a mapper circuitry operable to obtain pairs of in-phase and quadrature-phase quantized components that collectively represent the input sample based on the quantized amplitude of the polar representation of the input sample and the phase of the input sample and modify at least one of the pairs based on the quantized quantization error associated with the input sample. The electronic device further includes a set of quadrature modulator circuitry operable to combine the in-phase and quadrature-phase quantized components of each pair to obtain a set of quantization components and output the set of quantization components that collectively represent the input sample with at least one of the set of quantization components being modified to reduce the quantization error associated with the input sample, with each quantization component corresponding to one of the set of power amplifier circuitry, one of the set of quantization bits that represents the quantized amplitude of the polar representation of the input sample, and the phase of the polar representation of the input sample.

In one exemplary embodiment, a method is performed by an electronic device having a circuitry electrically coupled to a set of power amplifier circuitry operable to collectively amplify an input signal having information. The method includes outputting, by the circuitry, a set of quantization components that collectively represents a sample of the input signal, with the set of quantization components corresponding to the set of power amplifier circuitry and being associated with a polar representation of the sample.

In another exemplary embodiment, each quantization component is associated with one of a set of quantization bits that represents a quantized amplitude of the polar representation of the sample.

In another exemplary embodiment, at least one power amplifier circuitry is configured to output power that is linearly proportional to another of the set of power amplifier circuitry.

In another exemplary embodiment, at least one power amplifier circuitry is configured to output power that is non-linearly proportional to another of the set of power amplifier circuitry.

In another exemplary embodiment, at least one of the set of components is modified to reduce a quantization error associated with the input sample.

In another exemplary embodiment, each component corresponds to one of the set of power amplifier circuitry, one of the set of quantization bits that represents the quantized amplitude of the polar representation of the sample, and/or a phase of the polar representation of the input sample.

In one exemplary embodiment, an electronic device includes a set of power amplifier circuitry operable to collectively amplify an input signal having information and a circuitry electrically coupled to the set of power amplifier circuitry and operable to output a set of quantization components that collectively represents a sample of the input signal, with the set of quantization components corresponding to the set of power amplifier circuitry and being associated with a polar representation of the sample.

In one exemplary embodiment, a method is performed by an electronic device having a set of power amplifier circuitry. The method includes amplifying, by the set of power amplifiers, a set of output signals that collectively represents an amplified sample of an input signal having information, with each output signal being associated with a quantized polar representation of the sample.

In another exemplary embodiment, each output signal is associated with one of a set of quantization bits that represents a quantized amplitude of the polar representation of the sample.

In another exemplary embodiment, at least one of the set of output signals is modified to reduce a quantization error associated with the input sample.

In another exemplary embodiment, each output signal corresponds to one of the set of power amplifier circuitry, one of a set of quantization bits that represents a quantized amplitude of the polar representation of the sample, or a phase of the polar representation of the input sample.

In one exemplary embodiment, an electronic device includes a set of power amplifier circuitry operable to amplify a set of output signals that collectively represents an amplified sample of an input signal having information. Further, each output signal is associated with a quantized polar representation of the sample.

The previous detailed description is merely illustrative in nature and is not intended to limit the present disclosure, or the application and uses of the present disclosure. Furthermore, there is no intention to be bound by any expressed or implied theory presented in the preceding field of use, background, summary, or detailed description. The present disclosure provides various examples, embodiments and the like, which may be described herein in terms of functional or logical block elements. The various aspects described herein are presented as methods, devices (or apparatus), systems, or articles of manufacture that may include a number of components, elements, members, modules, nodes, peripherals, or the like. Further, these methods, devices, systems, or articles of manufacture may include or not include additional components, elements, members, modules, nodes, peripherals, or the like.

Furthermore, the various aspects described herein may be implemented using standard programming or engineering techniques to produce software, firmware, hardware (e.g., circuitry), or any combination thereof to control a computing device to implement the disclosed subject matter. It will be appreciated that some embodiments may be comprised of one or more generic or specialized processors such as microprocessors, digital signal processors, customized processors and FPGAs and unique stored program instructions (including both software and firmware) that control the one or more processors to implement, in conjunction with certain non-processor circuitry, some, most, or all of the functions of the methods, devices and systems described herein. Alternatively, some or all functions could be implemented by a state machine that has no stored program instructions, or in one or more application specific integrated circuitry (ASICs), in which each function or some combinations of certain of the functions are implemented as custom logic circuitry. Of course, a combination of the two approaches may be used. Further, it is expected that one of ordinary skill, notwithstanding possibly significant effort and many design choices motivated by, for example, available time, current technology, and economic considerations, when guided by the concepts and principles disclosed herein will be readily capable of obtaining such software instructions and programs and ICs with minimal experimentation.

The term “article of manufacture” as used herein is intended to encompass a computer program accessible from any computing device, carrier, or media. For example, a computer-readable medium may include: a magnetic storage device such as a hard disk, a floppy disk or a magnetic strip; an optical disk such as a CD or DVD; a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a LAN. Of course, a person of ordinary skill in the art will recognize many modifications may be made to this configuration without departing from the scope or spirit of the subject matter of this disclosure.

Throughout the specification and the embodiments, the following terms take at least the meanings explicitly associated herein, unless the context clearly dictates otherwise. Relational terms such as “first” and “second,” and the like may be used solely to distinguish one entity or action from another entity or action without necessarily requiring or implying any actual such relationship or order between such entities or actions. The term “or” is intended to mean an inclusive “or” unless specified otherwise or clear from the context to be directed to an exclusive form. Further, the terms “a,” “an,” and “the” are intended to mean one or more unless specified otherwise or clear from the context to be directed to a singular form. The term “include” and its various forms are intended to mean including but not limited to. References to “one embodiment,” “an embodiment,” “example embodiment,” “various embodiments,” and other like terms indicate that the embodiments of the disclosed technology so described may include a particular function, feature, structure, or characteristic, but not every embodiment necessarily includes the particular function, feature, structure, or characteristic. Further, repeated use of the phrase “in one embodiment” does not necessarily refer to the same embodiment, although it may. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

1. A method, comprising:
by a user equipment device having a circuitry electrically coupled to a set of power amplifier circuitry operable to collectively amplify an input signal having information;
generating, by the circuitry, an initial set of quantization components that collectively represents a sample of the input signal;
determining, by the circuitry, a polar domain quantization error based on a difference between the sample and a reconstructed sample obtained by combining the initial set of quantization components;
combining, by the circuitry, the polar domain quantization error with at least one of the initial set of quantization components to generate one or more error compensated quantization components included in an updated set of quantization components; and
outputting, by the circuitry, the updated set of quantization components, each of the updated set of quantization components having a respective amplitude and a respective phase and corresponding to a respective one of the set of power amplifier circuitry, with the updated set of quantization components being associated with a polar representation of the sample.

2. The method of claim 1, wherein each quantization component is associated with one of a set of quantization bits that represents a quantized amplitude of the polar representation of the sample.

3. The method of claim 1, wherein at least one power amplifier circuitry is configured to output power that is linearly proportional to another of the set of power amplifier circuitry or at least one power amplifier circuitry is configured to output power that is non-linearly proportional to another of the set of power amplifier circuitry.

4. The method of claim 1, wherein at least one of the set of quantization components is modified to reduce a quantization error associated with the sample.

5. The method of claim 1, wherein each quantization component corresponds to one of the set of power amplifier circuitry, one of a set of quantization bits that represents a quantized amplitude of the polar representation of the sample, and a phase of the polar representation of the sample.

6. A user equipment device, comprising:
a set of power amplifier circuitry operable to collectively amplify an input signal having information; and
a circuitry electrically coupled to the set of power amplifier circuitry and operable to:
generate an initial set of quantization components that collectively represents a sample of the input signal;
determine a polar domain quantization error based on a difference between the sample and a reconstructed sample obtained by combining the initial set of quantization components;
combine the polar domain quantization error with at least one of the initial set of quantization components to generate one or more error compensated quantization components included in an updated set of quantization components; and
output the updated set of quantization components, each of the updated set of quantization components having a respective amplitude and a respective phase and corresponding to a respective one of the set of power amplifier circuitry, with the updated set of quantization components being associated with a polar representation of the sample.

7. The device of claim 6, wherein each quantization component is associated with one of a set of quantization bits that represents a quantized amplitude of the polar representation of the sample.

8. The device of claim 6, wherein at least one power amplifier circuitry is configured to output power that is linearly proportional to another of the set of power amplifier circuitry or at least one power amplifier circuitry is configured to output power that is non-linearly proportional to another of the set of power amplifier circuitry.

9. The device of claim 6, wherein at least one of the set of quantization components is modified to reduce a quantization error associated with the sample.

10. The device of claim 6, wherein each component signal corresponds to one of the set of power amplifier circuitry, one of a set of quantization bits that represents a quantized amplitude of the polar representation of the sample, and a phase of the polar representation of the input sample.

11. A method, comprising:
by a user equipment device having a set of power amplifier circuitry,
amplifying, by the set of power amplifier circuitry, a set of output signals that collectively represents an amplified sample of an input signal having information, with the set of output signals being associated with a set of quantization components that collectively represents the sample, wherein at least one output signal of the set of output signals corresponds to an error compensated quantization component generated by combining a polar domain quantization error with at least one of the set of quantization components, the polar domain quantization error being determined based on a difference between the sample and a reconstructed sample obtained by combining an initial set of quantization components that collectively represents the sample, each of the quantization components having a respective amplitude and a respective phase and corresponding to a respective one of the set of power amplifier circuitry.

12. The method of claim 11, wherein each output signal is associated with one of a set of quantization bits that represents a quantized amplitude of a polar representation of the sample.

13. The method of claim 11, wherein at least one power amplifier circuitry is configured to output power that is linearly proportional to another of the set of power amplifier circuitry or at least one power amplifier circuitry is configured to output power that is non-linearly proportional to another of the set of power amplifier circuitry.

14. The method of claim 11, wherein at least one of the set of output signals is modified to reduce a quantization error associated with the sample.

15. The method of claim 11, wherein each output signal corresponds to one of the set of power amplifier circuitry, one of a set of quantization bits that represents a quantized amplitude of a polar representation of the sample, and a phase of the polar representation of the sample.

16. A user equipment device, comprising:
a set of power amplifier circuitry operable to amplify a set of output signals that collectively represents an amplified sample of an input signal having information, with the set of output signals being associated with a set of quantization components that collectively represents the sample, wherein at least one output signal of the set of output signals corresponds to an error compensated quantization component generated by combining a polar domain quantization error with at least one of the set of quantization components, the polar domain quantization error being determined based on a difference between the sample and a reconstructed sample obtained by combining an initial set of quantization components that collectively represents the sample, each of the quantization components having a respective amplitude and a respective phase and corresponding to a respective one of the set of power amplifier circuitry.

17. The device of claim 16, wherein each output signal is associated with one of a set of quantization bits that represents a quantized amplitude of a polar representation of the sample.

18. The device of claim 16, wherein at least one power amplifier circuitry is configured to output power that is linearly proportional to another of the set of power amplifier circuitry or at least one power amplifier circuitry is configured to output power that is non-linearly proportional to another of the set of power amplifier circuitry.

19. The device of claim 16, wherein at least one of the set of output signals is modified to reduce a quantization error associated with the sample.

20. The device of claim 16, wherein each output signal corresponds to one of the set of power amplifier circuitry, one of the set of quantization bits that represents the quantized amplitude of a polar representation of the sample, and a phase of the polar representation of the sample.
